(19) United States
(12) Patent Application Publication
(10) Pub. No.: US 2025/0067853 A1
(43) Pub. Date: Feb. 27, 2025

(54) METHOD AND SETUP FOR LIGHT DETECTION AND RANGING

(71) Applicant: Ecole Polytechnique Fédérale de Lausanne (EPFL), Lausanne (CH)

(72) Inventors: Anton LUKASHCHUK, Lausanne (CH); Johann RIEMENSBERGER, St-Sulpice (CH); Tobias KIPPENBERG, Aran (CH)

(73) Assignee: Ecole Polytechnique Fédérale de Lausanne (EPFL), Lausanne (CH)

(21) Appl. No.: 18/720,341

(22) PCT Filed: Dec. 17, 2021
(86) PCT No.: PCT/EP2021/086510

§ 371 Date: Jun. 14, 2024

(51) Int. Cl. G01S 7/4913; G01S 7/481; G01S 7/4915; G01S 17/89

(52) U.S. Cl. CPC G01S 7/4913; G01S 7/4814; G01S 7/4816; G01S 7/4915; G01S 17/89

(57) ABSTRACT

A method and a setup for light detection and ranging are disclosed. The setup is configured to carry out the following method: generating signal radiation at multiple signal frequencies with an optical signal source, wherein the signal radiation exhibits random signal modulations preferably at each of the multiple signal frequencies, splitting the signal radiation into a target radiation part and a reference radiation part, directing the target radiation part towards a target, detecting a target signal, wherein the target signal is associated with a reflected portion of the target radiation part being reflected from the target, detecting a reference signal, wherein the reference signal is associated with the reference radiation part, and deriving at least one ranging information parameter from the target signal and the reference signal.

### TECHNICAL FIELD

The present invention relates to a method for light detection and ranging and a setup for performing said method.

### PRIOR ART

Light detection and ranging (LIDAR) is an optical sensing technology widely used for applications such as autonomous driving, imaging, or industrial monitoring. LIDAR systems may vary with respect to their operational principle; in particular with respect to the type of light source used (e.g. continuous-wave or pulsed), the detection technique (e.g. coherent detection or incoherent detection), the optical wavelength of the light source, and the scanning method.

“Random Modulation Continuous-Wave (RMCW)” LIDAR is a particular operation principle which uses randomly modulated optical radiation to interrogate a target. Retrieving a time delay and thereby a distance is accomplished by correlating the modulations on an first optical radiation portion which has been reflected from the target with the modulations on a second optical radiation portion which is used as a reference.

The publication by N. Takeuchi et al., “Random modulation cw lidar,” Appl. Opt. 22, 1382-1386, (1983), DOI: 10.1364/AO.22.001382 discloses a continuous-wave (cw) Argon-laser, which is modulated by an electro-optical modulator with a pseudorandom code and used as a light source for RMCW LIDAR in an aerosol measurement. The backscattered light is demodulated to yield a demodulation signal, which is then directly cross-correlated with the pseudorandom code that acts as a reference.

In particular for applications such as sensing and imaging related to autonomous driving, fast scanning over a large spatial target range is required. To this end, LIDAR techniques have been proposed which rely on parallelization, i.e. on the use of optical radiation emitted at many different wavelengths/optical frequencies simultaneously. The different wavelengths/optical frequencies may be spatially dispersed using dispersive optical elements, which enables a larger simultaneous spatial coverage of the target and thus a faster signal acquisition speed. WO2021098975A1 discloses a LIDAR device comprising using laser light having a comb-like frequency spectrum with a plurality of laser frequencies, which are each frequency modulated with a frequency modulation, a method which is generally known as “Frequency modulated continuous-wave (FMCW) LIDAR”. In WO2021098975A1, a diffractive element spatially separates the laser light according to the laser frequencies and directs the spatially separated laser light towards a ranging region, with each of the laser frequencies being directed towards a corresponding spatially distinct target position in the ranging region. A detector receives reflections of the laser light from the ranging region and measures, by simultaneously detecting a frequency modulation of the reflections for each of the laser frequencies, a distance and/or a velocity at the target position. However, in order to obtain satisfying measurement results, high demands are placed on the light source, i.e. the plurality of laser frequencies needs to exhibit low phase noise while still being widely tunable. Furthermore, monitoring of the frequency modulation and linearization and/or pre-distortion may be required. Furthermore, the measurement integration time and thus the achievable signal-to-noise ratio cannot easily be varied without changing and potentially recalibrating the waveform of the frequency modulation.

### SUMMARY OF THE INVENTION

In a first aspect, it is an object of the present invention to provide a method for light detection and ranging (LIDAR), which alleviates the challenges mentioned above and with which ranging information about a target is obtained in an unambiguous and interference-immune fashion at fast scanning rates.

This object is achieved by a method for light detection and ranging according to claim 1. Further embodiments of the invention are laid down in the dependent claims.

A method for light detection and ranging is disclosed. The method comprises:
generating signal radiation at multiple signal frequencies with an optical signal source, wherein the signal radiation exhibits random signal modulations;
splitting the signal radiation into a target radiation part and a reference radiation part;
directing the target radiation part towards a target;
detecting a target signal, wherein the target signal is associated with a reflected portion of the target radiation part being reflected from the target;
detecting a reference signal, wherein the reference signal is associated with the reference radiation part, and
deriving at least one ranging information parameter from the target signal and the reference signal.

The multiple signal frequencies allow for a parallelization of measurements, which in turn enables fast scanning of the target. The random signal modulations enable unambiguous ranging and significantly reduces a risk of interference with other LIDAR systems, which is a crucial advantage in particular for applications such as autonomous driving. In order to cover large spatial target range simultaneously, the method preferably comprises spatially dispersing the multiple signal frequencies of the target radiation part using a dispersive element, such as e.g. a diffraction grating or a prism.

The ranging information parameter may be at least one of a time delay τ_{d}, a distance d and a velocity v. The ranging information parameter may be derived by cross-correlating the target signal and the reference signal to obtain a cross-correlation time signal, and a time delay and/or a distance may be inferred from the cross-correlation time signal. In particular, the distance d to the target may be inferred from a time delay τ_{d} obtained from a cross-correlation time signal according to

$$d = \frac{c}{2} arg {max}_{τ} ( XCORR [ {I}_{T} , {I}_{R} ] )$$

wherein c is the speed of light, I_{T} is the target signal (e.g. a target signal current obtained from a target photoreceiver module), I_{R} is the reference signal (e.g. a reference signal current obtained from a reference photoreceiver module), wherein the function XCORR [A, B] is a cross-correlation function (such as e.g. “xcorr” in MATLAB), which measures the similarity between a vector A and shifted (lagged) copies of a vector B as a function of a lag, the lag in this case being the time delay τ and wherein argmaxₓ (f(x)) returns values of x for which the function value f(x) is a maximum.

In the context of the present disclosure, the term “splitting” refers to splitting radiation power independently of the radiation frequency.

In this disclosure, the term “wavelength” and “optical frequency” and “optical angular frequency” are used interchangeably, since a wavelength can always be converted into an optical (angular) frequency by taking into consideration the propagation medium.

The term “random signal modulations” is meant to comprise noise-like modulations, such as white noise, but also pseudo-random modulations, which may be obtained using a random-signal generator.

In particular, the random signal modulations may be random amplitude modulations and/or random phase modulations. Intrinsically, random phase modulations can always be expressed as random frequency modulations.

Using the method according to the present invention, a distance resolution value ΔR may be obtained which depends inversely on a modulation bandwidth B of the random amplitude modulations (AM) and/or phase modulations (PM), wherein B=ΔAMₛ in the case of random amplitude modulations/noise, B=ΔPMₛ in the case of random phase modulations/noise or B=ΔFMₛ when the latter are expressed as random frequency modulations/noise (FM). In the present disclosure, the term “modulation bandwidth” preferably refers to a full-width-at-half-maximum FWHM (in linear scale) or a 3-dB bandwidth (in logarithmic scale) of a modulation frequency distribution, which may be expressed as a noise power spectral density. In case of PM/FM modulations, an instantaneous phase of the signal radiation at each of the multiple signal frequencies may be determined, for instance via coherent detection (an explanation of coherent detection can be found further below). Said instantaneous phase may then be differentiated to obtain an instantaneous PM/FM modulation frequency. This instantaneous PM/FM modulation frequency randomly jitters over an observation time, leading to a PM/FM modulation frequency distribution having a FWHM referred to as the “phase modulation bandwidth ΔPMₛ”/“frequency modulation bandwidth ΔFMₛ” for each of the multiple signal frequencies. Analogously, in case of amplitude modulations, the signal radiation at each of the multiple signal frequencies may be decomposed into instantaneous AM modulation frequencies (for instance by sending the signal radiation onto a photodiode and performing a Fourier-transform of a direct current (DC) measured with the photodiode) to determine an AM modulation frequency distribution having a FWHM referred to as the “amplitude modulation bandwidth ΔAMₛ”. For white-noise type modulations with a high-frequency cut-off frequency, i.e. modulations that exhibit a flat-top power spectral density up to said high-frequency cut-off frequency, the FWHM of the modulation frequency distribution does not depend on the observation time. For other types of noise modulations, the FWHM and thus the modulation bandwidth may vary with the observation time. For the modulation bandwidth values mentioned in this disclosure, the observation time is 10 μs.

Preferably, the signal radiation exhibits the random signal modulations at each of the multiple signal frequencies. The modulation bandwidth of the random signal modulations may be different for each of the multiple signal frequencies. Preferably however, the modulation bandwidth of the random signal modulations is similar or equal for each of the multiple signal frequencies, which may be achieved by generating the signal radiation from a single optical source such that the signal radiation exhibits a comb-like spectrum comprising a plurality of comb lines, wherein each comb line corresponds to one of the multiple signal frequencies, as will be described in further detail below.

In the present context, the term “distance resolution” refers to a longitudinal (or axial) resolution, i.e. a minimum resolvable distance between two targets on a single optical path travelled by the target radiation. In case the random signal modulations exhibits a flat-top power spectral density with a finite modulation bandwidth B, the distance resolution can be inferred directly from an auto-correlation function. According to the Wiener-Khinchin theorem, the auto-correlation function is the Fourier transform of the power spectral density. The Fourier transform of a rectangular function with the width B is a sinc-function with first zero-crossings at ΔT=±1/B. Following the convention that two sinc-functions can be resolved if the maximum of the second sinc-function corresponds to the position of the minimum of the first sinc-function leads to the following expression for the distance resolution value ΔR:

$$Δ R = \frac{c Δ T}{2} = \frac{c}{2 B}$$

wherein c denotes the speed of light Hence, the larger the modulation bandwidth, the shorter the distance resolution value ΔR. In other terms, a higher/better distance resolution is obtained by increasing the modulation bandwidth B.

In case the random modulations are amplitude modulations leading to a pulse sequence, i.e. a random sequence of ones and zeros, one may assume the pulse width to be 1/B as a time resolution unit and may then obtain the same equation for the distance resolution.

Mathematically, a distance precision is a standard deviation of an estimated value and the impact of random noise on said estimation. Montgomery and O'Donoghue studied a least-squares-fit problem with a sinusoidal signal in presence of random uncorrelated noise in M.H. Montgomery and D. Odonoghue, “A derivation of the errors for least squares fitting to time series data,” Delta Scuti Star, Newsletter 13, 28 (1999). The analytical formula for precision reads as

$${σ}_{f} = \sqrt{\frac{6}{{N}_{s}}} \frac{1}{π T} \frac{1}{\sqrt{SNR}} = \sqrt{\frac{6}{{f}_{s}}} \frac{1}{π \sqrt{SNR}} {T}^{- 3 / 2}$$

where Nₛ is a number of samples, T is a measurement time and SNR stands for signal-to-noise ratio. From this, an estimate for the distance precision σ_{R} may be obtained:

$$\begin{matrix}{σ}_{R} = \frac{cT}{4 B} {σ}_{f} = \frac{c}{2 B} \sqrt{\frac{6}{{N}_{s}}} \frac{1}{2 π} \frac{1}{\sqrt{SNR}} \\ = \sqrt{\frac{6}{{N}_{s}}} \frac{1}{2 π} \frac{Δ R}{\sqrt{SNR}}\end{matrix}$$

The distance precision improves with a higher SNR, but follows a square root power law. It also improves with the number of samples, which can be reformulated in terms of a measurement time, a sampling rate or even a chirp bandwidth if the latter is linked to the sampling rate.

For RMCW LIDAR a rigorous derivation of the Cramer-Rao lower bound on time delay estimation variance for bandwidth-limited white Gaussian signals with uncorrelated white noise can be found in G. C. Carter, “Coherence and time delay estimation,” in Proceedings of the IEEE, vol. 75, no. 2, pp. 236-255, (1987), DOI: 10.1109/PROC.1987.13723:

$${σ}_{τ}^{2} = \frac{3}{8 {π}^{2}} \frac{1 + 2 {SNR}_{pd}}{{SNR}_{pd}^{2}} \frac{1}{{B}^{3} T}$$

where SNR_{pd} denotes the SNR of the target signal after its detection, but prior to cross-correlation with the reference signal. In RMCW LIDAR, the target signal has a low SNR, since the target signal is spread over the whole bandwidth and noise variance dominates over the target signal variance. Assuming SNR_{pd}<<1, the expression for the distance precision may be written as:

$${σ}_{R} = \sqrt{\frac{6}{{N}_{s}}} \frac{1}{2 π} \frac{Δ R}{{SNR}_{pd}} .$$

In order to facilitate parallelization using diffractive optics to simultaneously cover a large spatial target area, the signal frequencies are preferably discrete and are spaced preferably by an essentially constant signal frequency spacing. Furthermore, the random signal modulations preferably have a modulation bandwidth being smaller than said frequency spacing. This enables a detection of the random signal modulations for each signal frequency individually by “demultiplexing” the signal radiation, wherein “demultiplexing” refers to decomposing the signal radiation into its different signal frequency components. In the context of the present disclosure, the term “channel” refers to a spectral section spanning a wavelength/optical frequency range which may be defined by a demultiplexing unit. In order to enable demultiplexing using standard demultiplexing units with standard channel as known in the art of optical communication, the frequency spacing is preferably larger than 10 GHz, ideally corresponding to a spacing used in standard commercial demultiplexing units such as 50 GHZ, 100 GHz or 200 GHz.

The reference signal and the target signal may be detected in a so-called direct detection scheme, i.e. where only the amplitude modulations of the reference and the target signal are detected. In such a case, the target signal and the reference signal are preferably obtained by
demultiplexing the reflected portion of the target radiation part into multiple target channels, wherein each target channel comprises one of the multiple signal frequencies;
demultiplexing the reference radiation part into multiple reference channels, wherein each reference channel comprises one of the multiple signal frequencies;
forming multiple channel pairs, wherein each channel pair comprises one target channel and one reference channel, wherein for each channel pair the signal frequency comprised by the target channel and the signal frequency comprised by the reference channel are the same;
wherein the target signal is detected for the target channel of each channel pair, and
wherein the reference signal is detected for the reference channel of each channel pair. The target signal and the reference signal may then be cross-correlated to obtain a cross-correlation time signal for each channel pair.

Detecting the target signal and the reference signal in such a direct detection scheme is preferably performed using highly sensitive photoreceiver modules such as avalanche photodiodes or photomultipliers.

Instead or in addition to direct detection, a coherent detection scheme may also be used, which implies that both the signal amplitude modulations and the signal phase modulations may be detected. In this case, the method may further comprise:
generating local-oscillator radiation with an optical local-oscillator source,
splitting the local-oscillator radiation into a first local-oscillator radiation part and a second local-oscillator radiation part,
combining the first local-oscillator radiation part with the reference radiation part and combining the second local-oscillator radiation part with the reflected portion of the target radiation part, and
detecting the reference signal and the target signal via coherent detection.

Coherent detection is a technique known in the art and may be implemented in a variety of ways, as described by K. Kikuchi, “Fundamentals of Coherent Optical Fiber Communications,” in Journal of Lightwave Technology, vol. 34, no. 1, pp. 157-179, (2016), Doi: 10.1109/JLT.2015.2463719, the content of which is herein incorporated by reference. In particular, coherent detection may comprise:
detecting an in-phase component and a quadrature component of each target signal using a target IQ-detector, and/or
detecting an in-phase component and a quadrature component of each reference signal using a reference IQ-detector,
   wherein the target IQ-detector and/or the reference IQ-detector may be a “phase-diversity homodyne receiver” as described in FIG. 6 of the reference by K. Kikuchi.

Alternatively, coherent detection may comprise:
detecting an in-phase component of each target signal using heterodyne detection, and/or,
detecting an in-phase component of each reference signal using heterodyne detection, for instance as described in FIG. 3 of the reference by K. Kikuchi.

The calculation of the signal-to-noise ratio (SNR) for random-modulation continuous-wave LIDAR includes two steps: the coherent detection of the target signal and the reference signal and their cross-correlation. The latter closely follows the discussion outlined in chapter 8 of J. S. Bendat and A. G. Piersol, “Random Data: Analysis and Measurement Procedures,” John Wiley & Sons, (2011), ISBN: 978-1-118-21082-6. To simplify the derivation, the random signal modulations are considered to be bandwidth-limited white Gaussian noise with a zero mean. A simple model for a target current signal x and reference current signal y currents for one channel pair after coherent detection may be considered,

$$x ( t ) = s ( t - {τ}_{d} ) + m ( t )$$

$$y ( t ) = s ( t ) + n ( t )$$

$${R}_{xx} ( 0 ) = {R}_{ss} ( 0 ) + {R}_{mm} ( 0 ) = S + N$$

$${R}_{yy} ( 0 ) = {R}_{ss} ( 0 ) + {R}_{nn} ( 0 ) = S + M$$

$${R}_{xy} ( τ ) = {R}_{ss} ( τ - {τ}_{d} )$$

where s(t) represents the contribution to the current from the initial random signal, m(t) and n(t) are noise terms that appear after photodetection due to shot noise, thermal noise and other possible noise sources, and Ta is a delay of the target current signal relative to the reference current signal, Rₓₓ/R_{yy} stand for auto-correlation and R_{xy} stands for cross-correlation. The SNR of the current y, for example, reads as SNR_{y}= [symbol] s² [symbol] /♯m² [symbol] =Rₛₛ(0)/Rₘ(0)=S/M. All of these terms are mutually uncorrelated. An attenuation coefficient for the s (t−τ_{d}) term was omitted for simplicity, since the ratio of the amplitudes S and M, N matters rather than the absolute value of S. To calculate the SNR of the cross-correlation trace between the target current signal x and the reference current signal y the maximum of the cross-correlation function squared may be taken and may be divided by its variance SNR=R_{xy}²(τ_{d})/Var[R_{xy}(τ)]. The denominator term in case of bandwidth-limited white Gaussian noise signals x, y can be estimated as

$$Var [ {R}_{xy} ( τ ) ] \approx \frac{1}{2 BT} [ {R}_{xx} ( 0 ) {R}_{yy} ( 0 ) + {R}_{xy}^{2} ( τ ) ]$$

where B is a signal noise bandwidth and T is a time length of x and y and T>>τ_{d}. Taking an upper bound for the variance estimate of cross-correlation at τ=τ_{d}, the value of SNR may be approximated as

$$\begin{matrix}SNR \approx {R}_{xy}^{2} ( {τ}_{d} ) / Var [ {R}_{xy} ( {τ}_{d} ) ] \\ = 2 BT / [ 2 + M / S + N / S + ( M / S ) ( N / S ) ]\end{matrix}$$

Two more assumptions may be made: the first assumption is that the reference current signal has a much higher SNR than the signal current (S/M)>>(S/N). This may be a reasonable assumption since the reference radiation part may be sent to the detector without any loss, while the target radiation part arm may experience free-space optical loss. The second assumption is that the SNR of the imaged photocurrent is much less than one, i.e. S/N<<1. Not only is this a realistic assumption, but it may also be a desired property in spread spectrum communications and military applications supporting optical analogue of electronic counter-countermeasures and low probability of interception. In RMCW the spectrum is spread out resulting in much lower SNR at the photodetection stage, but the SNR will be boosted taking cross-correlation. Under these assumptions, one may finally obtain

$$SNR \approx 2 BT ( \frac{S}{N} ) .$$

Effectively, the photocurrent SNR (that is S/N) gets multiplied by a time-bandwidth product. If one uses a Nyquist sampling rate of fₛ=2B the SNR would read as

$$SNR \approx {f}_{s} T ( \frac{S}{N} ) ,$$

where fₛT is simply a number of sampled data points. Furthermore, the value of S/N may be estimated, where S stands for an initial random target signal current variance and N is a variance of the photodetection noise, or, equivalently this ratio equals the ratio of power spectral densities at f<B of signal and noise currents, considering them to be flat. A shot-noise limited heterodyne detection with unity quantum efficiency may be assumed. To distinguish the SNR at different stages, i.e. the signal-to-noise ratio after coherent detection SNR_{pd} and the signal-to-noise ratio after cross-correlation SNR_{corr}, we apply the notation

$${SNR}_{corr} = 2 BT ( \frac{S}{N} ) = 2 BT * {SNR}_{pd}$$

Two random signals, one of which is a true signal (target current signal) and the other is random noise, have an SNR determined as a ratio of variances of their currents, i.e.

$${SNR}_{pd} = \frac{( σ {I}_{T}^{2} )}{( σ {I}_{n}^{2} )} .$$

The variance of the target signal may be expressed as σI_{T}²∝2P^{sig}P^{LO}, while the variance of the noise σIₙ²∝2ℏω_{LO}P^{LO}Δv_{RBW}, wherein P^{LO} denotes the optical power of the local-oscillator radiation at the local-oscillator angular frequency ω_{LO}. The resolution bandwidth Δv_{RBW} equals the sampling rate, since the time-domain variance of the current noise is determined by the number of the shot noise photons collected during the sampling time. The ratio of the variances leads to

$${SNR}_{pd} = \frac{〈 σ {I}_{s}^{2} 〉}{〈 σ {I}_{n}^{2} 〉} = \frac{{P}^{sig}}{{ℏω}_{sig} {R}_{s}} ,$$

wherein P^{sig} denotes the optical power of the signal radiation at the signal angular frequency ω_{sig}. By considering a sampling rate Rₛ to be twice the noise bandwidth, i.e. Rₛ=2B, the SNR which may be expressed as

$$SNR = \frac{{P}^{sig}}{{ℏω}_{sig} {B}_{RF}}$$

where the resolution bandwidth B_{RF} is the inverse of the measurement time T. In RMCW, the measurement time T may be arbitrarily varied, since no periodicity occurs.

Preferably, the local-oscillator radiation is generated at multiple local-oscillator frequencies. When using an optical local-oscillator source emitting multiple local-oscillator frequencies, the target signal and the reference signal are preferably obtained by
demultiplexing the local-oscillator radiation into multiple local-oscillator channels, wherein each local-oscillator channel comprises one of the local-oscillator frequencies;
splitting the local-oscillator radiation of each local-oscillator channel into a first local-oscillator sub-channel and a second local-oscillator sub-channel;
combining said first local-oscillator sub-channel with the reference channel of one of the channel pairs for coherent detection of the reference signal;
combining said second local-oscillator sub-channel with the target channel of said one of the channel pairs for coherent detection of the target signal.

Preferably, the local-oscillator frequencies are discrete and are spaced by an essentially constant local-oscillator frequency spacing. Furthermore, the local-oscillator frequency spacing is preferably essentially equal to a signal frequency spacing of the multiple signal frequencies. When combining the first (second) local-oscillator sub-channel with the reference (target) channel, the signal frequency in the reference (target) channel is associated with the local-oscillator frequency in the first (second) local-oscillator sub-channel it is being combined with, thereby creating a signal/local-oscillator frequency pair. A radio beat signal may be generated between the signal frequency and the local-oscillator frequency within each signal/local-oscillator frequency pair. In a case where the local-oscillator frequency spacing is exactly equal to the signal frequency spacing and where there is no global offset between the multiple local-oscillator frequencies and the multiple signal frequencies, said radio beat signal may then be at DC. Here, the local-oscillator frequency spacing is considered to be “essentially equal” to the signal frequency spacing of the multiple signal frequencies if, for a given detector bandwidth of a detector used to detect the reference signal and the target signal via coherent detection, the radio beat signal does not exceed said given detector bandwidth.

The signal radiation may exhibit random signal phase modulations and/or random signal amplitude modulations having a signal phase modulation bandwidth and/or a signal amplitude modulation bandwidth, respectively, which are preferably larger than 500 MHZ (corresponding to a distance resolution of approximately 30 cm or less), preferably larger than 1 GHZ (corresponding to a distance resolution of approximately 15 cm or less). The local-oscillator radiation on the other hand preferably exhibits random local-oscillator phase modulations having a local-oscillator phase modulation bandwidth being smaller, ideally significantly smaller, than the signal phase modulation bandwidth. Additionally or alternatively, the local-oscillator radiation preferably exhibits random local-oscillator amplitude modulations having a local-oscillator amplitude modulation bandwidth being smaller, ideally significantly smaller, than the signal amplitude modulation bandwidth.

In order to be able to obtain a meaningful ranging parameter by coherent detection using the local-oscillator radiation, the local-oscillator radiation should preferably exhibit a coherence length which is larger than twice the distance to the target. The coherence length is intrinsically determined by the local-oscillator phase modulation bandwidth: the larger the local-oscillator phase modulation bandwidth, the smaller the coherence length of the local-oscillator radiation. Preferably, for targets at a distance of 150 m or more from the optical local-oscillator source, the local-oscillator phase modulation bandwidth may be 1 MHz or less. In particular, for targets at a distance of 300 m or more from the optical local-oscillator source, the local-oscillator phase modulation bandwidth is preferably 0.5 MHz or less. Minimizing the local-oscillator phase modulation bandwidth and or the local-oscillator amplitude modulation bandwidth may also help avoiding signal-to-noise degradation of the reference signal and the target signal.

In case the target is moving, the target radiation part being reflected from the target may experience a frequency shift due to the Doppler-effect, which may deteriorate the signal-to-noise ratio of the cross-correlation time signal obtained from the target signal and the reference signal and may thus hinder a retrieval of the correct time delay. In order to alleviate this issue, the method may further comprise:
Fourier-transforming the target signal to obtain a target spectrum;
Fourier-transforming the reference signal to obtain a reference spectrum;
cross-correlating the target spectrum and the reference spectrum to obtain a cross-correlation spectrum;
extracting a Doppler-frequency shift from the cross-correlation spectrum;
calculating a frequency-shifted target signal based on said Doppler-frequency shift,
cross-correlating the frequency-shifted target signal with the reference signal to obtain a corrected cross-correlation time signal; and
extracting a ranging information parameter associated with the target from the corrected cross-correlation time signal.

Mathematically, the Doppler-frequency shift ΔfD may be extracted using the expression

$$Δ {f}_{D} = arg {max}_{f} ( XCORR [ [ {I}_{T} ] , [ {I}_{R} ] ] ) ,$$

where [symbol] [⋅] stands for the Fourier transform and where the expression XCORR [ [symbol] [I_{T}], [symbol] [I_{R}]] corresponds to the cross-correlation spectrum, i.e. the cross-correlation of the target spectrum [symbol] [I_{T}] and the reference spectrum [symbol] [I_{R}]. A target velocity v may then be inferred using the relation

$$v = \frac{c}{2 {f}_{s}} Δ {f}_{D} ,$$

where fₛ is the optical signal frequency used in the measurement. The correct time delay τ_{d} and thus the correct distance value d is then easily obtained via cross-correlation of the frequency-shifted target signal Ĩ_{T} with the reference signal I_{T}.

$$\tilde{{I}_{t}} = {- 1}^{} [ [ {I}_{T} ] ( f - Δ {f}_{D} ) ] ,$$

$$d = \frac{c}{2} arg {max}_{τ} ( XCORR [ , {I}_{R} ] ) ,$$

wherein [symbol] ⁻¹[⋅] denotes the inverse Fourier transform. All cross-correlations and Fourier transforms are preferably calculated by the evaluation arrangement digitally in batch processing using a software tool such as MATLAB. However, analog processing of cross-correlations is also conceivable. Straightforward computation of the cross-correlation may yield a computational complexity 0(N²), wherein N is a number of samples. Recalling that convolution operation can be calculated by the means of the Fourier transforms, i.e. the inverse Fourier transform of the multiplication of the Fourier transforms, the complexity may be estimated as ≈3×4N*log₂(N). However, taking into account prior information from a preceding distance estimation step or a neighboring pixel and restricting ourselves to a limited search range around the previous value, we assume that the cross-correlation complexity can be estimated as 0(M*N) if calculated directly, where M<<N and potentially M<3×4*log₂(N).

The target velocity v has a sign that is reflected in the sign of the Doppler-frequency shift Δf_{D}. In a case where the radio beat signal generated by beating the signal frequency with the local-oscillator frequency happens to be at DC as described above, determining the sign of the Doppler-frequency shift Δf_{D} is not straightforward. By introducing a relative shift between the signal frequencies and the local-oscillator frequencies, the radio beat signal may be shifted away from DC, and hence said sign of the Doppler-frequency shift may easily be determined, which then in turn provides information about whether the target is moving towards the signal source oscillator or away from the signal source oscillator. The method may thus further comprise shifting the multiple signal frequencies by a global frequency shift with respect to the multiple local-oscillator frequencies of the local-oscillator radiation in order to enable a non-zero radio beat signal frequency between the multiple signal frequencies and the multiple local-oscillator frequencies. The radio beat signal may have a frequency corresponding to said global frequency shift. This relative shift is particularly advantageous when balanced photodetectors are used to detect the reference signal and the target signal, since in that case, the sign of the Doppler-frequency shift is detectable directly without having to explicitly detect an in-phase component and a quadrature component of the target signal and/or the reference signal. The global frequency shift is ideally chosen such that the radio beat signal for each signal/local-oscillator frequency pair still lies within the detector bandwidth. In particular, the global frequency shift may be between 1-10 GHZ, preferably 5 GHz.

As will be explained in greater detail further below, the optical signal source may comprise a signal microresonator pumpable by a continuous-wave laser, wherein said continuous-wave laser is preferably configured to emitting pump light at a wavelength/optical frequency which is eye-safe. The signal microresonator may define multiple microresonator resonance frequencies which exhibit a resonance bandwidth and which are spaced by a free-spectral range (FSR) that is inversely proportional to a circumference of the signal microresonator and that also depends on a dispersion profile of the signal microresonator. The dispersion profile in turn depends on cross-sectional dimensions of the signal microresonator.

Generating the signal radiation exhibiting the random signal modulations may comprise operating the signal microresonator in a modulation-instability regime in a modulation-instability regime. The term “modulation-instability regime” refers to an operation regime in which optical radiation propagating within the signal microresonator exhibits spatio-temporal chaos, i.e. an operation regime where random amplitude modulations and random phase modulations occur. For a theoretical and experimental investigation of such an operation regime, the inventors refer to A. B. Matsko et al., “Chaotic dynamics of frequency combs generated with continuously pumped nonlinear microresonators,” Opt. Lett. 38, 525-527, (2013), DOI: 10.1364/OL.38.000525, the contents of which are herein incorporated by reference.

The signal radiation generated by operating the signal microresonator in a modulation-instability regime may exhibit a comb-like spectrum comprising a plurality of comb lines, wherein each comb line corresponds to one of the multiple signal frequencies, and wherein each comb line exhibits strong amplitude noise and/or phase noise. By superposing a comb line with narrow-band and stable reference radiation emitted by a reference source on a fast photodiode, a noisy radio frequency beat signal may be recorded using a radio signal analyzer. When the signal microresonator is operated in the modulation-instability regime, said radio frequency beat signal may have a bandwidth which significantly exceeds the resonance bandwidth of the microresonator resonance frequencies. Said noisy radio frequency beat signal may be used to measure the modulation bandwidth of the amplitude and/or phase noise and to optimize said modulation bandwidth in order to obtain a desired distance resolution value as described above.

In order to operate the signal microresonator in a modulation-instability regime, the wavelength/optical frequency of the pump light emitted by the continuous-wave laser may be tuned to overlap with one of the microresonator resonance frequencies. Depending on the type of continuous-wave laser, tuning the optical frequency of the pump light may be accomplished by tuning a drive current applied to continuous-wave laser, and/or by tuning a temperature set point at which the continuous-wave laser is operated and/or, if the continuous-wave laser comprises a piezo-electric actuator, by actuating said piezo-electric actuator. Alternatively or additionally, the multiple resonance frequencies of the signal microresonator may also be thermally tuned, preferably using a Peltier-element or an integrated heater arranged on or below or adjacent to the signal microresonator, or mechanically tuned via a piezo-electric element arranged to exert stress on the signal microresonator.

Preferably, the optical frequency of the pump light emitted by the continuous-wave laser is tuned into one of the microresonator resonance frequencies from a “blue end” of said microresonator resonance frequency while keeping a constant pump light average power, wherein from tuning from the “blue end” refers to tuning from higher optical frequencies/shorter wavelengths towards lower optical frequencies/longer wavelengths. As the wavelength of the pump light emitted by the continuous-wave laser is tuned into the microresonator resonance frequency, the signal radiation may be generated within the signal microresonator with an intra-microresonator average power that increases the closer the wavelength of the pump light gets to the microresonator resonance frequency. At the same time, the increasing intra-microresonator average power leads to a red-shift, i.e. a shift towards lower optical frequencies, of the microresonator resonance frequency due to the Kerr-effect and due to thermal effects. To trigger parametric oscillations within the signal microresonator leading to the generation of the multiple signal frequencies, the pump light average power may need to exceed a threshold power which decreases quadratically with an increasing quality (Q)-factor of the signal microresonator, wherein the quality (Q)-factor is defined as the ratio of the microresonator resonance frequency and the full width at half-maximum (FWHM) bandwidth of said resonance frequency. Preferably, the pump light average power is in a range of 50 mW to 5 W.

As described above, better distance resolution is obtained by increasing the modulation bandwidth of the random signal modulations. To this end, a stability chart may be determined, wherein the stability chart has the pump light average power on a first axis and the frequency detuning between the optical frequency of the pump light and the microresonator resonance frequency on a second axis. Said stability chart may comprise a pre-soliton switching zone, which may define an edge of a modulation-instability zone. Tuning further into a bistable region of the stability chart may cause the microresonator to switch into a coherent regime, e.g. either a dissipative Kerr soliton-regime or a continuous-wave regime. The optimum operation point, i.e. an optimal combination of pump light average power and frequency detuning leading to the largest modulation bandwidth, may be found at the end of a monostable branch before entering the bistable region. Experimentally, the optimum operation point may be verified by observing the bandwidth of the radio frequency beat signal as described above while tuning the optical frequency of the pump light into the microresonator resonance. Operating the signal microresonator in such a modulation-instability state may be done deterministically using the stability chart described above. The modulation-instability state may furthermore be thermally self-locked.

If the signal microresonator exhibits an intrinsic loss rate κ₀ that is fixed, the distance resolution may be improved by increasing a coupling rate κₑₓ (defined as a rate at which the pump light enters/leaves the microresonator from/to a bus waveguide carrying the pump light arranged tangentially to the microresonator) from a critically coupled state κₑₓ=κ₀ to reach an overcoupled state, e.g. κₑₓ=9κ₀. Increasing of the coupling rate κex provides a more effective photon flux into the signal microresonator, which leads to a higher intracavity power inside the signal microresonator and thus a stronger red-shift due to the Kerr effect, which in turn increases the bandwidth of the random signal modulations and thus yields a better distance resolution. In practical terms, the coupling rate κex may be increased by arranging the bus waveguide closer to the microresonator. Furthermore, a higher pump power of the pump light also may lead to a better distance resolution.

In an alternative embodiment, the optical signal source may comprise a laser oscillator configured to emit a frequency comb and a modulator, and generating the signal radiation exhibiting the random signal modulations may comprise:
running the laser oscillator such that it emits the frequency comb, and
randomly modulating said frequency comb using the modulator such that the frequency comb exhibits random modulations.

Alternatively, the optical signal source may comprise a continuous-wave laser and a modulator, preferably an electro-optic modulator, wherein generating the signal radiation exhibiting the random signal modulations may comprise:
generating continuous-wave radiation using the continuous-wave laser, and
generating a randomly modulated frequency comb from said continuous-wave radiation using the modulator. Generating frequency combs using electro-optic modulators is known in the art and an overview of methods is described by A. Parriaux et al., “Electro-optic frequency combs,” Adv. Opt. Photon. 12, 223-287, (2020), DOI: 10.1364/AOP.382052, the content of which is herein incorporated by reference. The random signal modulation may in such a case by obtained by superposing a random noise signal to a main signal driving the modulator.

In yet another alternative embodiment, the optical signal source may comprise multiple single-frequency laser modules, wherein each single-frequency laser module is configured to emit randomly modulated radiation at one of the multiple signal frequencies, and wherein generating the signal radiation exhibiting the random signal modulations may comprise:
generating randomly modulated radiation with each single-frequency laser module at one of the multiple signal frequencies, and
combining the randomly modulated radiation of each single-frequency laser module to create the signal radiation. Generating randomly modulated radiation with each single-frequency laser may comprise driving each single-frequency laser in a chaotic state, or driving a modulator using a pseudo-random waveform generator, wherein the modulator may be arranged to modulate the radiation of all the multiple single-frequency laser modules simultaneously, or wherein each single-frequency laser module may be associated with a separate modulator driven by a common pseudo-random waveform generator.

The optical local-oscillator source may comprise a local-oscillator microresonator pumpable by a continuous-wave laser. In this case, generating the local-oscillator radiation preferably comprises operating the signal microresonator in a soliton regime. The soliton regime may be a single-soliton state which may be achieved using a soliton state switching process known in the art, e.g. as disclosed in U.S. Pat. No. 10,270,529B2, the content of which is herein incorporated by reference. During the soliton state switching process, a frequency detuning between a resonance of the local-oscillator microresonator and an optical frequency of the pump light emitted by the continuous-wave laser being tuned into said resonance may be monitored via the phase modulation response technique as described by H. Guo et al., “Universal dynamics and deterministic switching of dissipative Kerr solitons in optical microresonators.” Nature Physics 13, 94-102, (2017), DOI: 10.1038/nphys3893, the content of which is herein incorporated by reference.

Alternatively, the optical local-oscillator source may comprise a laser oscillator configured to emit a frequency comb and generating the local-oscillator radiation may comprise running the laser oscillator such that it emits the frequency comb.

In an alternative embodiment, the optical local-oscillator source may comprise a continuous-wave laser and an electro-optic modulator, and generating the local-oscillator radiation may comprise:
generating continuous-wave radiation using the continuous laser, and
generating a frequency comb from said continuous-wave radiation using the electro-optic modulator.

In yet another alternative embodiment, the optical local-oscillator source may comprise multiple single-frequency laser modules, wherein each single-frequency laser module is configured to emit radiation at one of the multiple local-oscillator frequencies, and generating the local-ocillator radiation may comprise:
generating radiation with each single-frequency laser module at one of the multiple signal frequencies, and
combining the radiation of each single-frequency laser module to create the local-oscillator radiation.

In a preferred case where the optical signal source comprises a signal microresonator and the optical local-oscillator source comprises a local-oscillator microresonator, the method preferably comprises pumping said signal microresonator and said local-oscillator microresonator using a common continuous-wave laser. In this case, individual tuning of the signal microresonator and/or the local-oscillator microresonator may be performed by using additional tuning means such as Peltier elements or piezoelectric elements or integrated heaters acting individually on each of the microresonators.

In a second aspect, it is an object of the present invention to provide a setup for light detection and ranging. Any statements made herein with regard to the method for light detection and ranging described likewise apply to the setup for light detection and ranging and vice versa.

The setup comprises:
at least one optical signal source being configured to generate signal radiation at multiple signal frequencies, wherein the signal radiation exhibits random signal modulations;
at least one signal splitter being configured to split the signal radiation into a target radiation part and a reference radiation part;
at least one detection arrangement being configured to detect a target signal, wherein the target signal is associated with a reflected portion of the target radiation part being reflected from a target, and a reference signal, wherein the reference signal is associated with the reference radiation part, and
at least one evaluation arrangement being configured to derive at least one ranging information parameter from the target signal and the reference signal.

The evaluation arrangement may comprise an analog-to-digital converter, and/or an oscilloscope and/or a data processing unit, such as a personal computer.

The optical signal source preferably comprises a signal microresonator pumpable by a continuous-wave laser such that the signal microresonator is operated in a modulation-instability regime.

Alternatively, the optical signal source may comprise a laser oscillator configured to emit a frequency comb and a modulator configured to randomly modulate said frequency comb. The laser oscillator may be a mode-locked laser, such as a mode-locked solid-state laser or a mode-locked fiber laser as known in the art.

In an alternative embodiment, the optical signal source may comprise a continuous-wave laser configured to emit continuous-wave radiation and an electro-optic modulator configured to generate a randomly modulated frequency comb from said continuous-wave radiation via electro-optic modulation.

In yet another alternative embodiment, the optical signal source may comprise multiple single-frequency laser modules, wherein each single-frequency laser module is preferably configured to emit randomly modulated radiation at one of the multiple signal frequencies.

In the embodiments described above using a modulator, the modulator may be an electro-optic or acousto-optic modulator and the optical signal source may further comprise a pseudo-random waveform generator configured to drive said modulator.

Independently of the embodiments, the optical signal source may further comprise an optical signal radiation amplifier, such as e.g. an erbium-doped fiber amplifier (EDFA), configured and arranged to amplify the signal radiation before it reaches the at least one signal splitter.

In order to enable parallelized coherent detection, the setup preferably comprises at least one optical local-oscillator source being configured to emit local-oscillator radiation preferably at multiple local-oscillator frequencies. Furthermore, the setup preferably comprises at least one local-oscillator splitter being configured to split the local-oscillator radiation into a first local-oscillator radiation part and a second local-oscillator radiation part. The detection arrangement may further be configured to detect the reference signal and the target signal via coherent detection by combining the first local-oscillator radiation part with the reference radiation part and combining the second local-oscillator radiation part with the reflected portion of the target radiation part.

The optical local-oscillator source preferably comprises a local-oscillator microresonator pumpable by a continuous-wave laser such that the local-oscillator microresonator is operated in a soliton-regime.

In such a case, the setup preferably comprises and the local-oscillator microresonator in combination with the signal microresonator, wherein both the local-oscillator microresonator and the signal microresonator are pumped by a common continuous-wave laser. Said common continuous-wave laser may be a semiconductor laser, such as an external cavity diode laser (ECDL) or a III-V hybrid integrated laser, e.g. indium phosphide (InP) on silicon (Si), or a fiber laser or any other laser emitting pump light at a wavelength which is preferably eye-safe, i.e. preferably at a wavelength of 1400 nm or longer, with a linewidth of less than 1 MHz, preferably less than 0.5 MHZ, in particular less than 0.1 MHz.

The setup may comprise an optical pump amplifier to amplify the pump light. The setup may comprise a pump splitter configured to split the pump light of the common continuous-wave laser into a signal pump part and a local-oscillator pump part. In such a case, the optical pump amplifier may be arranged before the pump splitter with respect to a direction of propagation of the pump light. Alternatively, the setup may comprise an optical signal pump amplifier arranged to amplify he signal pump part and/or an optical local-oscillator pump amplifier arranged to amplify the local-oscillator pump part. The optical (signal and/or local-oscillator) pump amplifier may for instance be an erbium-doped fiber amplifier (EDFA) or, to achieve a very compact setup, a semiconductor optical amplifier which may be integrated on a silicon substrate.

In order to be able to operate the signal microresonator in the modulation-instability regime and the local-oscillator in the soliton-regime when using said continuous-wave laser, the setup may further comprise Peltier elements or piezoelectric elements or integrated heaters acting individually on each of the microresonators. Such a common continuous-wave laser for both the local-oscillator microresonator and the signal microresonator provides the advantage of a particularly compact setup, as well as common pump light noise suppression. However, the optical local-oscillator source and the optical signal source may each comprise their own continuous-wave laser (e.g. of the same type and with the same properties as the common continuous-wave laser described above) for pumping the local-oscillator microresonator and the signal microresonator, respectively.

The signal microresonator may be integrated within a chip-scale signal platform and/or the local-oscillator microresonator may be integrated within a chip-scale local-oscillator platform. In particular, the signal microresonator and/or the local-oscillator microresonator may comprise or consist of silicon nitride (Si₃N4) and the chip-scale signal platform and/or the chip-scale local-oscillator platform may comprise a silicon substrate. In A. Gaeta et al, “Photonic-chip-based frequency combs,” Nature Photonics 13, 158-169, (2019), DOI:10.1038/s41566-019-0358-x, an overview explaining how such chip-scale platforms may be configured and fabricated is provided, which is herein incorporated by reference.

The chip-scale signal platform may comprise a signal coupling waveguide designed and arranged to couple the signal pump part into the signal microresonator. Analogously, the chip-scale local-oscillator platform may comprise a local-oscillator coupling waveguide designed and arranged to couple the local-oscillator pump part into the signal microresonator. The signal coupling waveguide and the local-oscillator coupling waveguide preferably consist of the same material as the signal micorresonator or the local-oscillator microresonator, respectively.

Alternatively, the optical local-oscillator source may comprise a laser oscillator configured to emit a frequency comb. The laser oscillator may be a mode-locked laser, such as a mode-locked solid-state laser or a mode-locked fiber laser, which directly emits the local-oscillator radiation as a frequency comb. In order to provide local-oscillator frequencies which are particularly stable, i.e. which exhibit random local-oscillator amplitude/phase modulations having a local-oscillator amplitude/phase modulation bandwidth being as small as possible, the mode-locked laser may be actively stabilized by a feedback system to suppress noise.

In an alternative embodiment, the optical local-oscillator source may comprise a continuous-wave laser configured to emit continuous-wave radiation and an electro-optic modulator configured to generate a frequency comb from said continuous-wave radiation via electro-optic modulation.

In yet another alternative embodiment, the optical local-oscillator source may comprise multiple single-frequency laser modules, wherein each single-frequency laser module is preferably configured to emit radiation at one of the multiple local-oscillator frequencies.

Preferably, the detection arrangement comprises:
a target demultiplexing unit comprising multiple target channels, wherein each target channel is configured to comprise one of the multiple signal frequencies;
a reference demultiplexing unit comprising multiple reference channels, wherein each reference channel is configured to comprise one of the multiple signal frequencies;
multiple target photoreceiver modules, wherein each target photoreceiver module is associated with one target channel;
multiple reference photoreceiver modules, wherein each reference photoreceiver module is associated with one reference channel,
wherein multiple channel pairs comprising each one target channel and one reference channel are formed, wherein for each channel pair the signal frequency comprised by the target channel and the signal frequency comprised by the reference channel are the same.

The detection arrangement is preferably configured to detect the target signal for the target channel of each channel pair using the target photoreceiver module associated with said target channel. Furthermore, the detection arrangement is preferably configured to detect the reference signal for the reference channel of each channel pair using the reference photoreceiver module associated with said reference channel.

The detection arrangement may further comprise:
a local-oscillator demultiplexing unit comprising multiple local-oscillator channels wherein each local-oscillator channel is configured to comprise one of the multiple local-oscillator frequencies;
multiple local-oscillator splitters configured to split the local-oscillator radiation of each local-oscillator channel into at least a first local-oscillator sub-channel and a second local-oscillator sub-channel;
wherein each reference photoreceiver module comprises a reference combination device combining said first local-oscillator sub-channel with one of the reference channels, and
wherein each target photoreceiver module comprises a target combination device combining said second local-oscillator sub-channel with one of the target channels.

Preferably, the target demultiplexing unit and/or the reference demulitplexing unit and/or the local-oscillator demultiplexing unit are fiber-coupled deceives, wherein the multiple target channels and/or the multiple reference channels and/or the multiple local-oscillator channels are each associated with an individual optical fiber. In particular, the target demultiplexing unit and/or the reference demulitplexing unit and/or the local-oscillator demultiplexing unit may be dense wavelength division demultiplexers (DWDM) as used in optical communication covering preferably a range between 1530-1565 nm with preferably 20-60 channels.

In order to be able to detect whether the Doppler-frequency shift has a positive sign or a negative sign and hence to be able to detect a movement direction of the target, each target photoreceiver module may be a target IQ-detector configured to detect an in-phase component and a quadrature component of the target signal, preferably comprising a first target balanced photodetector and a second target balanced photodetector.

Analogously, each reference photoreceiver module may be a reference IQ-detector configured to detect an in-phase component and a quadrature component of the reference signal, preferably comprising a first reference balanced photodetector and a second reference balanced photodetector.

In case the target photoreceiver module and/or reference photoreceiver module are IQ-detectors, each reference combination device and/or each target combination device is preferably an optical hybrid with a first input for the reference channel/the target channel and a second input for the first local-oscillator sub-channel to be combined with said reference channel/the second local-oscillator sub-channel to be combined with said target channel. The first input and the second input may each be split into a first branch and a second branch, wherein the first branch of the second input preferably comprises a 90°-phase shifter. The first branch of the second input may then be recombined with the first branch of the first input in a first 50:50-beam-combiner/beam splitter and the second branch of the second input may be recombined with the second branch of the first input in a second 50:50-beam combiner/beam splitter. The first 50:50-beam combiner/beam splitter preferably has two outputs which are then sent to the first reference/target balanced photodetector and the second 50:50-beam combiner/beam splitter preferably has two outputs which are then sent to a second reference/target balanced photodetector.

The setup may further comprise a frequency shifter configured to shift the multiple signal frequencies by a global frequency shift with respect to the multiple local-oscillator frequencies or vice versa. In particular, the frequency shifter may be a single sideband modulator. In an embodiment where the setup comprises a common continuous-wave laser emitting pump light which is split into a signal pump path for both the signal microresonator and a local-oscillator pump path for the local-oscillator microresonator, the frequency shifter may be arranged in the signal pump path between the continuous-wave-laser and the signal microresonator, such that the global frequency shift is already imprinted on the pump light before soliton generation.

In embodiments comprising such a frequency shifter, the photoreceiver modules do not need to be IQ-detectors in order to determine the sign of the Doppler-frequency shift. Instead of optical hybrids, simple 50:50 beam combiners/splitters with two inputs and two outputs may be used as the reference combination devices and/or as the target combination devices. Each target photoreceiver module then preferably comprises a target balanced photodetector, which is preferably arranged at the two outputs of the target combination device and/or each reference photoreceiver module preferably comprises a reference balanced photodetector which is preferably arranged at the two outputs of the reference combination device.

The balanced photodetectors may be based on silicon photodetectors and may preferably have a detection bandwidth of 10 GHz.

In order to cover large spatial target range simultaneously, the setup preferably further comprises a dispersive element, e.g. a diffraction grating or a prism, which is configured to spatially disperse the multiple signal frequencies of the target radiation part. To further enable fast spatial scanning of the target, the setup may further comprise at least one galvanometer mirror. The setup may furthermore include beam-shaping or beam-collecting optics, such as collimators, which may be arranged in particular at an interface between an optical fiber carrying the target radiation part and a free-space region, in which the target is situated.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1a shows a schematic illustration of a setup for light detection and ranging according to a first embodiment of the present invention, which is configured in a direct detection scheme;

FIG. 1b symbolically shows random amplitude modulations in the time-domain;

FIGS. 2a-c schematically show alternative embodiments of an optical signal source;

FIG. 3a shows a schematic representation of a setup for light detection and ranging according to a second embodiment of the present invention, which is configured in a coherent detection scheme;

FIG. 3b shows an enlarged schematic of a target or reference photoreceiver module;

FIGS. 4a-c schematically show alternative embodiments of an optical local-oscillator source;

FIG. 5a shows a schematic representation of a setup for light detection and ranging according to a third embodiment of the present invention, which is configured in a coherent detection scheme;

FIG. 5b schematically shows a global frequency shift as used in the third embodiment of the present invention;

FIG. 5c shows an enlarged schematic of a target or reference photoreceiver module;

FIGS. 6a-c schematically show alternative embodiments of an optical local-oscillator source;

FIG. 7 schematically shows how a ranging information parameter is retrieved from a target signal and a reference signal;

FIG. 8 shows a cross-correlation distance signal obtained from an experimentally measured target and reference signal;

FIG. 9 shows an optical spectrum of the signal radiation coupled out of a signal microresonator, while the signal microresonator is operated in a modulation-instability regime;

FIG. 10a shows an instantaneous frequency noise bandwidth a selection of comb lines of the signal radiation;

FIG. 10b shows distance resolution values associated with the selection of comb line of the signal radiation shown in FIG. 10a;

FIG. 10c shows a stability chart;

FIG. 11a shows a radio frequency spectrum of a radio beat signal generated by superposing a comb line of the signal radiation S with a nearest comb line of the local-oscillator radiation;

FIG. 11b shows an AM modulation frequency distribution plotted in terms of relative power in dB for the signal frequency of one comb line;

FIGS. 11c,d show a frequency distribution of an instantaneous signal frequency fs of one comb line of the signal radiation S with a mean value of the signal frequency fs having been subtracted;

FIG. 11e shows a histogram of amplitudes for one of the comb lines of the signal radiation S fitted by a Rice distribution;

FIG. 12a shows a point cloud corresponding to a LIDAR experiment where the target consisted of the four chess figures arranged in front of a carton background;

FIG. 12b shows a histogram of demonstrating a relative accuracy of the LIDAR experiment shown in FIG. 12a;

FIG. 13a schematically shows an excerpt of a measurement setup where the target is a rotating flywheel;

FIG. 13b shows a zoom into FIG. 13a;

FIG. 13c shows a measured point cloud of the flywheel representing distance values;

FIG. 13d shows a measured point cloud of the flywheel representing velocity values;

FIG. 13e-g show horizontal velocity profiles; and

FIGS. 14a-c illustrate a procedure to obtain distance and velocity values.

### DESCRIPTION OF PREFERRED EMBODIMENTS

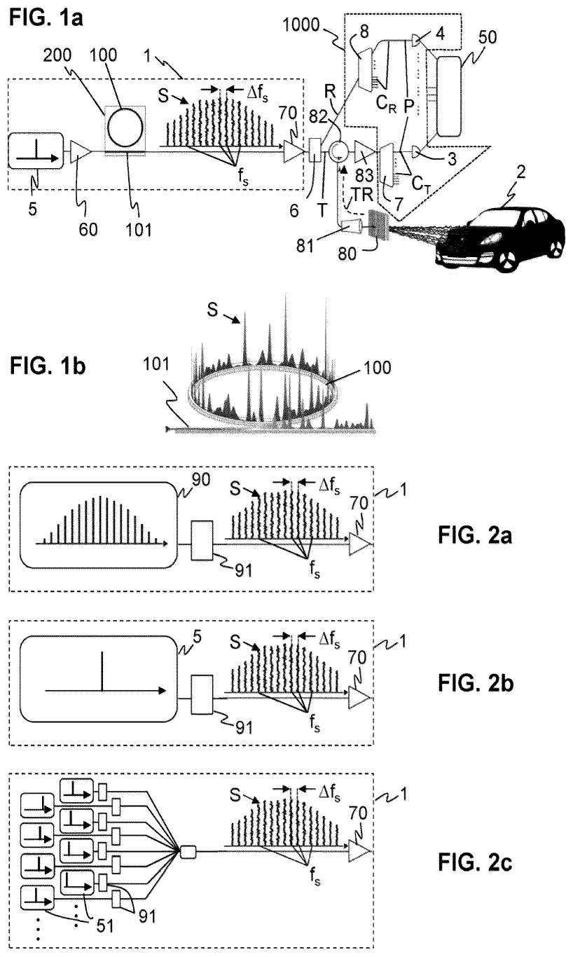

FIG. 1a shows a schematic illustration of a setup for light detection and ranging according to a first embodiment of the present invention, which is configured in a direct detection scheme. The setup comprises an optical signal source 1, which is configured to generate signal radiation S at multiple signal frequencies fₛ, wherein the signal radiation S exhibits random signal modulations. In the embodiment shown here, the optical signal source 1 comprises a signal microresonator 100 pumped by a continuous-wave (cw) laser 5, which is additionally amplified using an optical pump amplifier 60. As an example, the continuous-wave laser 5 may be an external-cavity diode laser (ECDL) emitting pump light at a wavelength around 1.5 μm and the optical pump amplifier 60 may be an erbium-doped fiber amplifier (EDFA), which amplifies said pump light to an average power of 2 W. Here, the signal microresonator 100 is integrated within a chip-scale signal platform 200. The chip-scale signal platform 200 further comprises a signal coupling waveguide 101, into which the amplified pump light exiting the pump amplifier 60 is coupled and which is arranged tangentially to the signal microresonator 100 such that at least a portion of the amplified pump light that has been coupled into the signal coupling waveguide 101 is injected into the signal microresonator 100 to generate the signal radiation S. The signal radiation S has a comb-like structure, wherein each of the multiple frequencies fₛ corresponds to one comb line and wherein the comb lines are essentially equally spaced by a spacing Δfₛ which is related to a free-spectral range (FSR) of the signal microresonator 100. The comb lines are drawn symbolically as blurred lines in FIG. 1a, since the random signal radiation S exhibits random signal modulations at each of the comb lines. Preferably, the random signal modulations are caused by operating the microresonator in a modulation-instability regime. Operating the microresonator in the modulation-instability regime cause each comb line to exhibit random phase modulations and random amplitude modulations.

In a direct detection scheme as depicted in FIG. 1a, only the random amplitude modulations are detected. In FIG. 1b, the random amplitude modulations are symbolically shown in the time-domain together with the signal microresonator 100 and the signal coupling waveguide 101 to illustrate that random amplitude modulations cause the signal radiation S to have a randomly pulsed character. The setup in FIG. 1a further comprises an optical signal radiation amplifier 70 and a signal splitter 6, wherein the optical signal radiation amplifier 70 is configured to amplify the signal radiation S and wherein here, the optical signal radiation amplifier 70 is arranged before the signal splitter 6. The signal beam splitter is configured to split the signal radiation into a target radiation part T and a reference radiation part R. The signal beam splitter is preferably a fiber-splitter configured to couple the target radiation part T and the reference radiation part R into separate optical fibers for easy handling. The target radiation part T is then directed towards a target 2, which is depicted as a car in this example (not to scale). A collimator element 81 is used as an interface between the optical fiber carrying the target radiation and a free-space region in which the target 2 is situated. In order to cover a large spatial target range simultaneously, the setup preferably further comprises a dispersive element 80, in a particular example e.g. a transmission grating with 966 lines/mm, which is configured to spatially disperse the multiple signal frequencies of the target radiation part. To further enable fast spatial scanning of the target, the setup may further comprise at least one galvanometer mirror (not explicitly shown in FIG. 1a). Ideally, the collimator element 81 is configured to collect a reflected portion TR of the target radiation part. In order to separate the target radiation part T propagating towards the target from the reflected portion TR of the target radiation part, the setup shown in this embodiment comprises a fiber optic circulator 82 known in the art. Instead of a fiber optic circulator, a free-space polarizing beam splitter may also be used. The setup further comprises a detection arrangement 1000 being configured to detect a target signal I_{T}, wherein the target signal I_{T} is associated with the reflected portion TR of the target radiation part being reflected from a target 2, and a reference signal I_{R}, wherein the reference signal I_{R} is associated with the reference radiation part R. Since the reflected portion TR of the target radiation part may have a small average power compared to the reference radiation, the setup as shown here comprises an optical target amplifier 83 configured to amplify the reflected portion TR of the target radiation part before it enters the detection arrangement 1000.

The detection arrangement 1000 comprises a target demultiplexing unit 7 comprising multiple target channels C_{T}, wherein each target channel C_{T} is configured to comprise one of the multiple signal frequencies fₛ, and a reference demultiplexing unit 8 comprising multiple reference channels C_{R}, wherein each reference channel C_{R} is configured to comprise one of the multiple signal frequencies fₛ. The detection arrangement 1000 further comprises multiple target photoreceiver modules 3, wherein each target photoreceiver module 3 is associated with one target channel C_{T} and multiple reference photoreceiver modules 4, wherein each reference photoreceiver module 4 is associated with one reference channel C_{R}. For simplicity, only one target channel C_{T} and one reference channel C_{R}, as well as only one target photoreceiver module 3 and one reference photoreceiver module 4 are explicitly drawn are in FIG. 1a, the rest are indicated by vertical dots. Multiple channel pairs P (only one explicitly shown in FIG. 1a) comprising each one target channel C_{R} and one reference channel CT are formed, wherein the one target channel C_{R} and the one reference channel C_{T} comprise the same signal frequency fₛ, i.e. in this case the same comb line of the comb-like spectrum emitted by the signal microresonator 100.

The detection arrangement 1000 is configured to detect a target signal I_{T} for the target channel C_{T} of each channel pair P using the target photoreceiver 3 module associated with said target channel C_{T}. Furthermore, the detection arrangement 1000 is configured to detect the reference signal I_{R} for the reference channel C_{R} of each channel pair P using a reference photoreceiver module 4 associated with said reference channel C_{R}.

The setup further comprises an evaluation arrangement 50 being configured to derive at least one ranging information parameter from the target signal I_{T} and the reference signal I_{R}.

FIGS. 2a-2c schematically show alternative embodiments of the optical signal source 1.

In FIG. 2a the optical signal source 1 comprises a laser oscillator 90 configured to emit a frequency comb and a modulator 91 configured to randomly modulate said frequency comb, the randomly modulated frequency comb then corresponding to the signal radiation S. The laser oscillator may be a mode-locked laser, such as a mode-locked solid-state laser or a mode-locked fiber laser.

In FIG. 2b the optical signal source 1 comprises a continuous-wave laser 5 configured to emit continuous-wave radiation and a modulator 91, in this case an electro-optic modulator, configured to generate a randomly modulated frequency comb from said continuous-wave radiation.

In FIG. 2c the optical signal source 1 comprises multiple single-frequency laser modules 51, wherein each single-frequency laser module 51 is configured to emit randomly modulated radiation at one of the multiple signal frequencies fₛ. In the example shown here, each single-frequency laser module 51 is individually connected to a modulator 91 to generate the random modulations and the randomly modulation radiation of each single-frequency laser module 51 is then combined, thereby creating the signal radiation S.

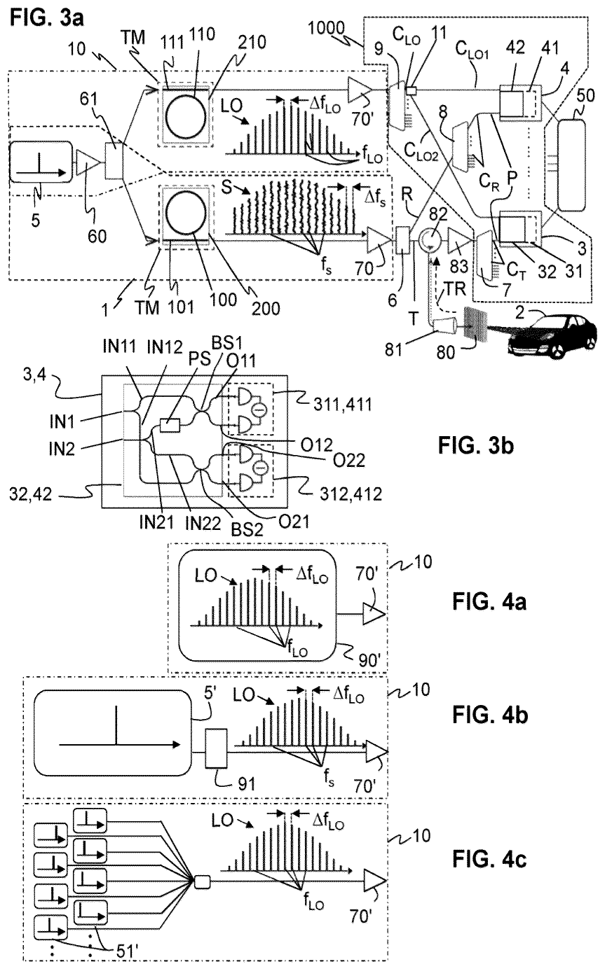

FIG. 3a shows a schematic representation of a setup for light detection and ranging according to a second embodiment of the present invention, which is configured in a coherent detection scheme. In addition to all features already shown and described in FIG. 1a, this setup further comprises an optical local-oscillator source 10 being configured to emit local-oscillator radiation LO preferably at multiple local-oscillator frequencies f_{LO} to enable parallelized coherent detection. In the embodiment shown here, the local-oscillator source 10 comprises a local-oscillator microresonator 110 pumped by the same continuous-wave (cw) laser 5 amplified by the pump amplifier 60 that is pumping the signal microresonator 100. Preferably, the signal microresonator and the local-oscillator microresonator have essentially the same free-spectral range (FSR). Preferably, a difference in FSR due to fabrication tolerances may amount to 50 MHz or less. The setup comprises a pump splitter 61 configured to split the pump light of the common continuous-wave laser 5 into a signal pump part and a local-oscillator pump part. Here, the local-oscillator microresonator 110 is integrated within a chip-scale local-oscillator platform 210. The chip-scale local-oscillator platform 210 further comprises a local-oscillator coupling waveguide 111, into which the local-oscillator pump part is coupled and which is arranged tangentially to the local-oscillator microresonator 110 such that at least a portion of the local-oscillator pump part that has been coupled into the local-oscillator coupling waveguide 111 is injected into the local-oscillator microresonator 110 to generate the local-oscillator radiation LO. The local-oscillator radiation LO has a comb-like structure, wherein each of the multiple local-oscillator frequencies f_{LO} corresponds to one comb line and wherein the comb lines are essentially equally spaced by a spacing Δf_{LO} which is related to a free-spectral range (FSR) of the local-oscillator microresonator 110. The comb lines are drawn as straight lines in FIG. 3a (as compared to the blurry lines for the comb lines of the signal radiation S) to symbolically express that the comb lines of the local-oscillator radiation LO much more “stable” than the comb line of the signal radiation S, i.e. that the local-oscillator radiation preferably exhibits random local-oscillator phase modulations having a local-oscillator phase modulation bandwidth being ideally significantly smaller than the signal phase modulation bandwidth and that the local-oscillator radiation preferably exhibits random local-oscillator amplitude modulations having a local-oscillator amplitude modulation bandwidth being ideally significantly smaller than the signal amplitude modulation bandwidth.

Preferably, the comb-like random local-oscillator radiation LO is generated are caused by operating the local-oscillator microresonator in a soliton-regime, while the signal radiation S is generated by operating the signal microresonator in a modulation-instability regime. Since here, both the signal microresonator and the local-oscillator microresonator are both pumped by the common continuous-wave laser 5, additional tuning means TM are arranged underneath each of the microresonators to be able to tune their microresonator resonances individually. These tuning means TM may be Peltier elements or piezoelectric elements or integrated heaters.

The setup in FIG. 3a further comprises an optical local-oscillator radiation amplifier 70′ configured to amplify the local-oscillator radiation LO. The detection arrangement 100 is further configured to detect the reference signal I_{R} and the target signal I_{T} via coherent detection by combining the first local-oscillator radiation part with the reference radiation part R and combining the second local-oscillator radiation part with the reflected portion TR of the target radiation part. To enable parallelized coherent detection using the multiple local-oscillator frequencies f_{LO}, the detection arrangement 1000 comprises a local-oscillator demultiplexing unit 9 comprising multiple local-oscillator channels C_{LO}, wherein each local-oscillator channel C_{LO} is configured to comprise one of the multiple local-oscillator frequencies f_{LO}. The detection arrangement 100 further comprises multiple local-oscillator splitters 11 configured to split the local-oscillator radiation LO of each local-oscillator channel C_{LO} into at least a first local-oscillator sub-channel C_{LO1} and a second local-oscillator sub-channel C_{LO2}. Furthermore, the detection arrangement comprises multiple reference combination devices 42, wherein each reference combination device 42 is configured to combine said first local-oscillator sub-channel C_{LO} with one of the reference channels C_{R}, and multiple target combination devices 32, wherein each target combination device 32 is configured to combine said second local-oscillator sub-channel C_{LO2} with one of the target channels C_{T}, wherein said one of the target channels C_{T} and said one of the reference channels C_{R} are both configured to comprise the same one of the multiple signal frequencies fₛ.

FIG. 3b shows an enlarged schematic of the target photoreceiver module 3 (the reference photoreceiver module 4). Here, the target photoreceiver module 3 (reference photoreceiver module 4) is a target IQ-detector (a reference IQ-detector) configured to detect an in-phase component and a quadrature component of the target signal (the reference signal), and comprises a first target balanced photodetector 311 (a first reference balanced photodetector 411) and a second target balanced photodetector (a second reference balanced photodetector 412). The target combination device 32 (reference combination device 42) is an optical hybrid with a first input IN1 for the target channel C_{T} (the reference channel C_{R}) and a second input IN2 for the first local-oscillator sub-channel C_{LO1} (the second local-oscillator sub-channel C_{LO2}) to be combined with said target channel C_{T} (with said reference channel C_{R}). The first input IN1 and the second input IN2 may each be split into a first branch IN11, IN21 and a second branch IN12, IN22, wherein the first branch IN21 of the second input comprises a 90°-phase shifter PS. The first branch IN21 of the second input may then be recombined with the first branch IN11 of the first input in a first 50:50-beam-combiner/beam splitter BS1 and the second branch IN22 of the second input may be recombined with the second branch IN12 of the first input in a second 50:50-beam combiner/beam splitter BS2. The first 50:50-beam combiner/beam splitter has two outputs O11,O12 which are connected to the first target balanced photodetector 311 (the first reference balanced photodetector 411) and the second 50:50-beam combiner/beam splitter preferably has two outputs O21,O22 which the second target balanced photodetector 312 (the second reference balanced photodetector 412).

FIGS. 4a-4c schematically show alternative embodiments of the optical local-oscillator source 10.

In FIG. 4a the optical local-oscillator source 10 comprises a laser oscillator 90′ configured to emit a frequency comb. The laser oscillator may be a mode-locked laser, such as a mode-locked solid-state laser or a mode-locked fiber laser, which directly emits the local-oscillator radiation as a frequency comb.

In FIG. 4b the optical local-oscillator source 10 may comprise a continuous-wave laser 5′ configured to emit continuous-wave radiation and a modulator 91, in this case an electro-optic modulator configured to generate a frequency comb via from said continuous-wave radiation via electro-optic modulation.

In FIG. 4c the optical local-oscillator source 10 may comprise multiple single-frequency laser modules 51′, wherein each single-frequency laser module is configured to emit radiation at one of the multiple local-oscillator frequencies f_{LO}. The radiation of each single-frequency laser module 51′ is then combined, thereby creating the local oscillation LO.

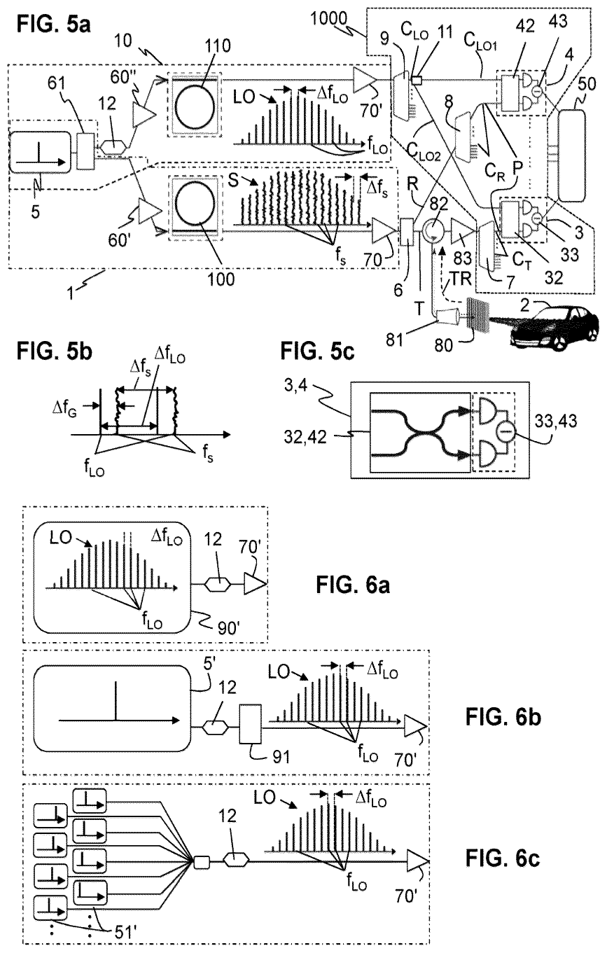

FIG. 5a shows a schematic representation of a setup for light detection and ranging according to a third embodiment of the present invention, which is configured in a coherent detection scheme. The setup shown here is very similar to the setup of the second embodiment shown in FIG. 3a. In addition, the setup shown here comprises a frequency shifter 12 configured to shift the multiple signal frequencies fₛ by a global frequency shift Δf_{G} with respect to the multiple local-oscillator frequencies f_{LO} or vice versa, as shown schematically in FIG. 5b. Here, the setup comprises a common continuous-wave laser 5 emitting pump light which is split by a pump splitter 61 into a signal pump path for both the signal microresonator 100 and a local-oscillator pump path for the local-oscillator microresonator 110, and the frequency shifter 12 is arranged in the signal pump path between the common continuous-wave laser 5 and the signal microresonator 100, such that the global frequency shift Δf_{G} is already imprinted on the pump light before soliton generation. Here, the setup comprises an optical signal pump amplifier 60′ arranged to amplify he signal pump part and an optical local-oscillator pump amplifier 60″ arranged to amplify the local-oscillator pump part after the pump splitter 61. In particular, having the optical signal pump amplifier 60′ arranged after the frequency shifter 12, as shown here, is advantageous if the frequency shifter is not designed to handle high power levels. Due to the global frequency shift Δf_{G}, no IQ-detectors are necessary in order to determine the sign of a Doppler-frequency shift caused by a moving target 2. Instead of optical hybrids, simple 50:50 beam combiners/splitters with two inputs and two outputs are used here as the reference combination devices 42 and as the target combination devices 32, respectively. As shown in FIG. 5c, each target photoreceiver module 3 then preferably comprises a target balanced photodetector 33, which is preferably arranged at the two outputs of the target combination device 31 and each reference photoreceiver module 4 preferably comprises a reference balanced photodetector 43 which is preferably arranged at the two outputs of the reference combination device 42.

FIGS. 6a-6c schematically show alternative embodiments of the optical local-oscillator source 10 similar to the embodiments shown in FIGS. 4a-4c. In addition, the alternative embodiments shown here each comprise the frequency shifter 12 for the purposes discussed above.

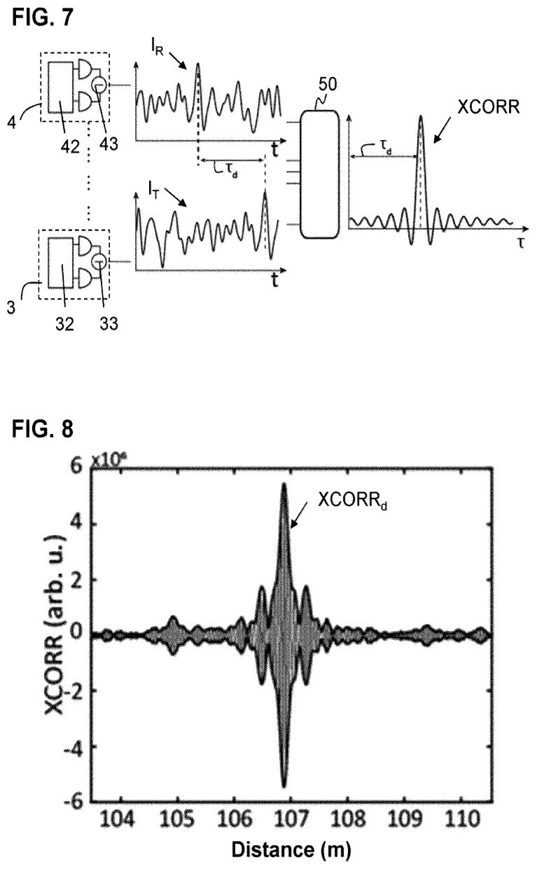

FIG. 7 schematically shows how a ranging information parameter, here in particular a time delay τ_{d}, is retrieved from the target signal I_{T} and the reference signal I_{R}, wherein the target signal detecting I_{T} preferably is a target current signal measured over time from the target photoreceiver module 3 and the reference signal I_{R} preferably is a reference current signal measured over time from reference photoreceiver module 4, where detection occurred as described in FIG. 5a. Preferably, the target signal I_{T} and the reference signal I_{R} are digitized using the evaluation arrangement 50 and subsequently cross-correlated to yield a cross-correlation time signal XCORR. According to the expression τ_{d}=argmax_{τ}(XCORR[I_{T},I_{R}]), a maximum of the cross-correlation time signal XCORR is determined to retrieve the time delay of interest τ_{d}.

FIG. 8 shows a cross-correlation distance signal XCORR_{d} obtained from an experimentally measured target and reference signal using one channel pair. The cross-correlation distance signal XCORR_{d} corresponds to the cross-correlation time signal XCORR, but is plotted as a function of distance instead of delay. In the measurement shown here, the time delay τ_{d} has been translated into a distance d=107 m, which corresponds to a path length difference travelled by the target radiation T relative to the reference radiation R.

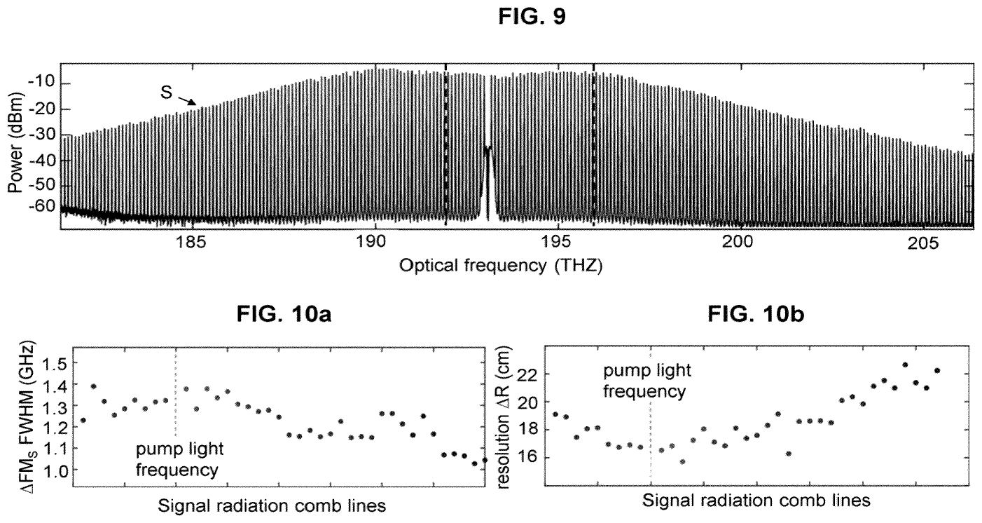

FIG. 9 shows an optical spectrum of the signal radiation S coupled out of the signal microresonator 100, while the signal microresonator 100 is operated in the modulation-instability regime. The signal microresonator 100 used to experimentally generate the signal radiation S shown here consists of silicon nitride (Si₃N₄) and has a free-spectral range (FSR) of 99 GHz. The residual pump light at 193 THz is filtered out. The signal radiation reaches high power per comb line of up to −5 dBm with a flat-top spectral shape spanning ˜8 THz in a 3 dB-span. The region between the dashed lines corresponds to the 40 comb lines used for LIDAR measurements. These 40 selected comb lines exhibit a power variation of less than 3 dB. A power transfer efficiency (pump light vs. power of the signal radiation S out of the signal microresonator) of >20% was achieved here. In comparison, when operating in the soliton regime, the power transfer efficiency typically reach less than 1% and is theoretically limited to ˜2%. An overcoupled signal microresonator resonance with a total linewidth of 180 MHz was chosen to increase the power per comb line and to attain a chaotic modulation-instability state with a high modulation/noise bandwidth.

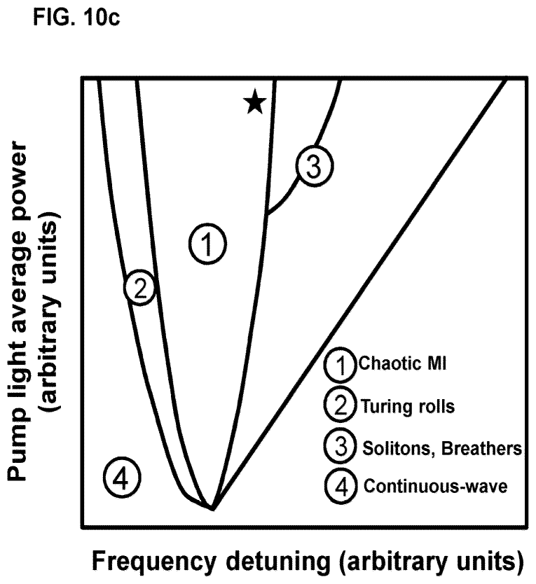

FIG. 10a shows an instantaneous frequency noise bandwidth ΔFMₛ (full width at half maximum (FWHM)) for each of the selected comb lines of the signal radiation S. The instantaneous frequency noise FWHM was determined by using a Hilbert-transform of the radio beat signal generated by superposing each comb line of the signal radiation S with the nearest comb line of the local-oscillator radiation LO, wherein the local-oscillator radiation LO is generated in the soliton-regime in the local-oscillator microresonator 110 and hence exhibits negligible random modulations compared to the signal radiation S. The local-oscillator microresonator 110 in this case had a free-spectral range (FSR) of approximately 99 GHz (within the fabrication tolerance of <50 MHZ). An associated distance resolution value (i.e. the smallest distance to distinguish between two semitransparent objects along the target beam path) was experimentally measured for each comb line shown in FIG. 10a. These distance resolution values are shown in FIG. 10b and as expected for the discussion above, the distance resolution values AR are inversely proportional to the frequency noise bandwidth ΔFMₛ. In both FIGS. 10a and 10b, a dashed line indicates a location of the optical frequency of the pump light used to pump the signal microresonator 100.

FIG. 10c shows a stability chart which has an average power of the pump light on a first axis and a frequency detuning between the optical frequency of the pump light and the signal/local-oscillator microresonator resonance frequency on a second axis. Different operation regimes (chaotic modulation-instabilities, turing rolls, soliton/breathers and continuous-wave) are indicated by circled numbers. The optimum operation point for the signal microresonator, i.e. an optimal combination of pump light average power and frequency detuning leading to the largest modulation bandwidth, may be found at the end of a monostable branch before entering the bistable region, as indicated by a star in FIG. 10c.

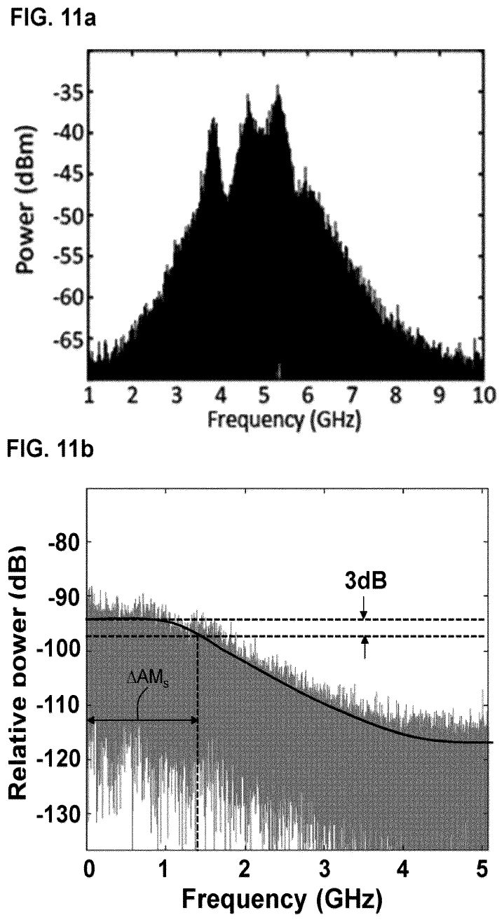

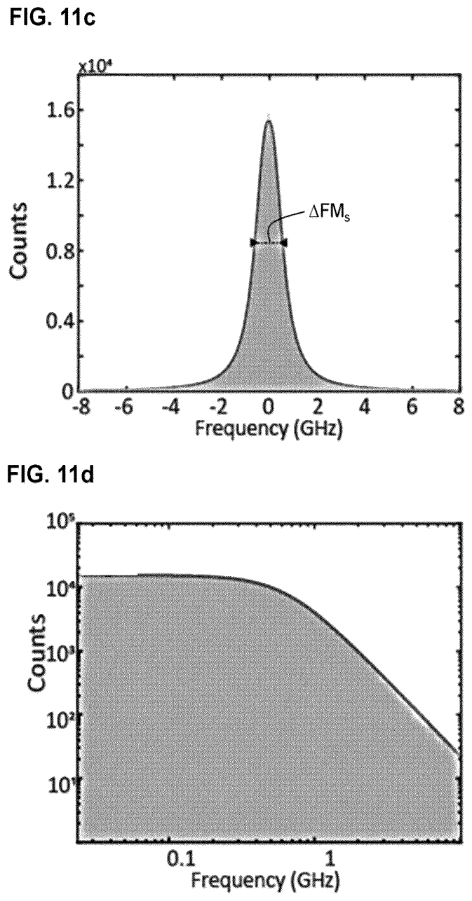

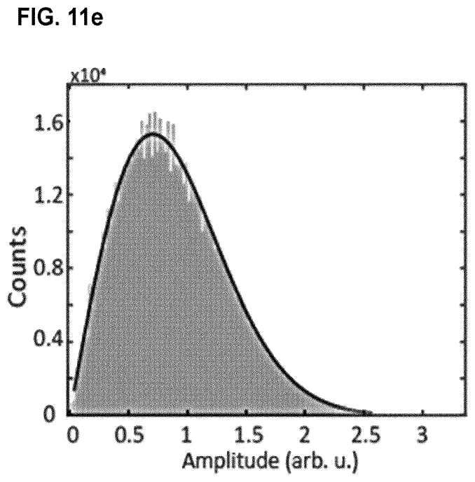

FIG. 11a shows a radio frequency spectrum of the radio beat signal generated by superposing one comb line of the signal radiation S with the nearest comb line of the local-oscillator radiation LO. As can be seen in FIG. 11a, the beat signal is centered around a radio frequency of 5 GHZ, which corresponds to the global frequency shift Δf_{G} that was imprinted on the local-oscillator radiation LO using a frequency shifter arranged as shown in FIG. 5a. An AC-coupled photoreceiver module was used combined with a radio-frequency amplifier having a high-pass cut-off at 550 MHz.

FIG. 11b shows an AM modulation frequency distribution plotted in terms of relative power in dB for the signal frequency fₛ of one comb line. The signal amplitude modulation bandwidth ΔAMₛ is indicated as the 3 dB-bandwidth.

FIGS. 11c and 11d show an FM modulation frequency distribution for the signal frequency fₛ of one comb line of the signal radiation S with the mean value of the signal frequency fₛ having been subtracted. The FM modulation frequency distribution has a FWHM that corresponds to the frequency modulation bandwidth ΔFMₛ. In this case, it was found that the FM modulation frequency distribution was best fitted with a Cauchy distribution of power ˜2.4. FIG. 11c shows the frequency distribution on a linear scale, while FIG. 11d shows it on a double-logarithmic scale.

FIG. 11e shows a histogram of amplitudes for one of the comb lines of the signal radiation S fitted by a Rice distribution.

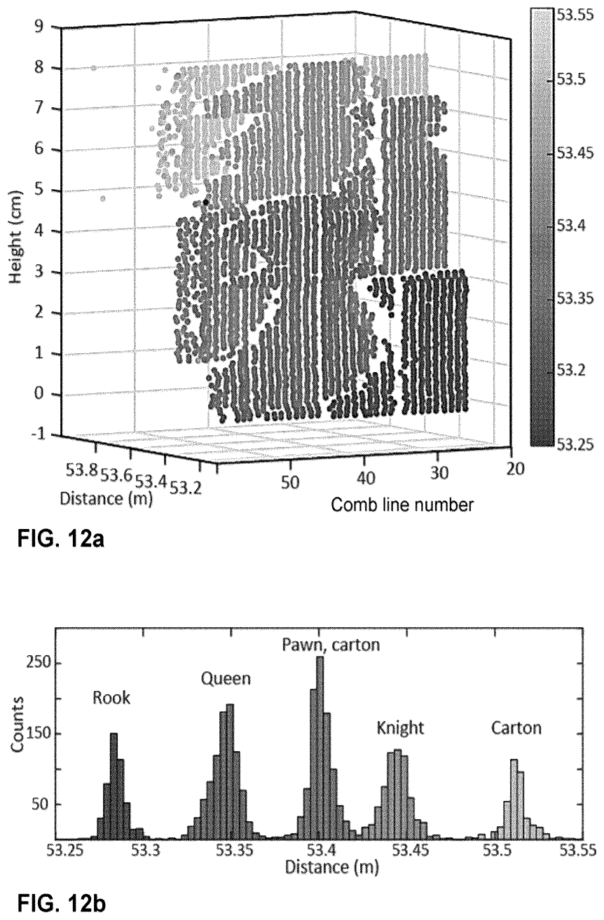

FIG. 12a shows a point cloud corresponding to a LIDAR experiment where the target consisted of the four chess figures arranged in front of a carton background. The target radiation originating from the signal microresonator operated in the modulation-instability regime was amplified up to 2 W and dispersed in free-space by a 966 lines/mm grating. The beam was scanned in a vertical direction by a mirror galvanometer. The four chess figures (Rook, Queen, Pawn, King) were placed approximately ˜1 m in front of a polarizing beam-splitter and the mirror galvanometer, wherein the polarizing beam-splitter was used to separate the target radiation part propagating towards the target from the reflection portion of the target radiation part. A major part of the distance delay (105 m) comes from a fiber path difference between reference and target arms. The detection was performed sequentially with 40 channel pairs, scanned across 100 positions in the vertical direction, leading to a point cloud of 40×100 pixels. Each pixel was measured for a measurement time of 10 μs. A histogram of the pixel detections demonstrates relative accuracy of the ranging in FIG. 12b. Compared to a measurement carried out with a measurement time of 1 μs (not shown here), the longer measurement time of 10 us allows for better detection of faint signals such as object edges and enables LIDAR with a low SNR. To verify the distance measurement accuracy, a fiber chromatic dispersion measurement was performed using a known single-mode optical fiber, in this case with a specified dispersion of <18 ps/nm/km corresponding to ˜0.7 ns delay or ˜25 cm difference in measured distance between 192 THz and 196 THz. A fitted slope for 35 comb lines (i.e. 35 signal frequencies fₛ) yielded a dispersion of 17.2 ps/nm/km, showing that relative channel-to-channel accurate and precise distance measurements are possible for every signal frequency fₛ, without any need for prior system calibration and linearization.

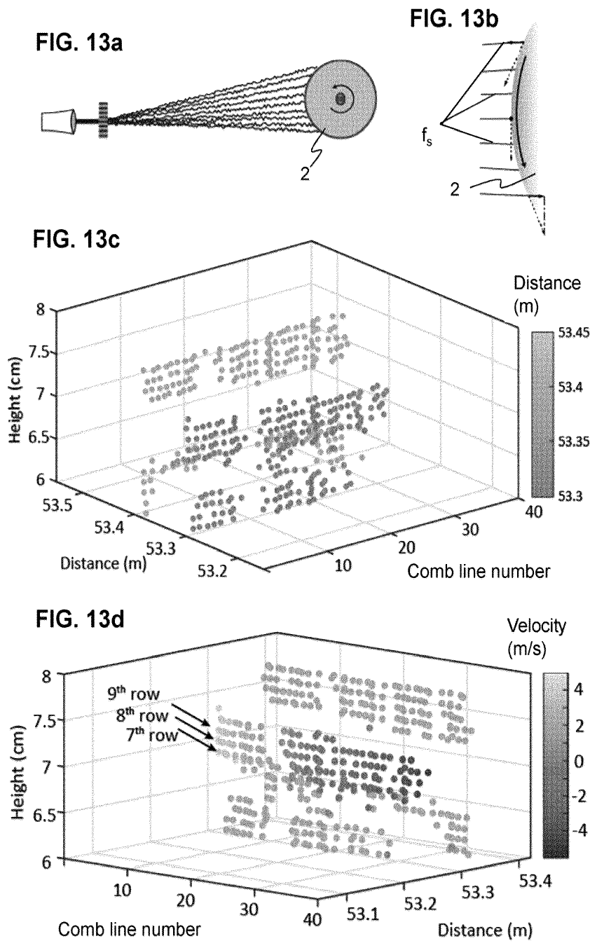

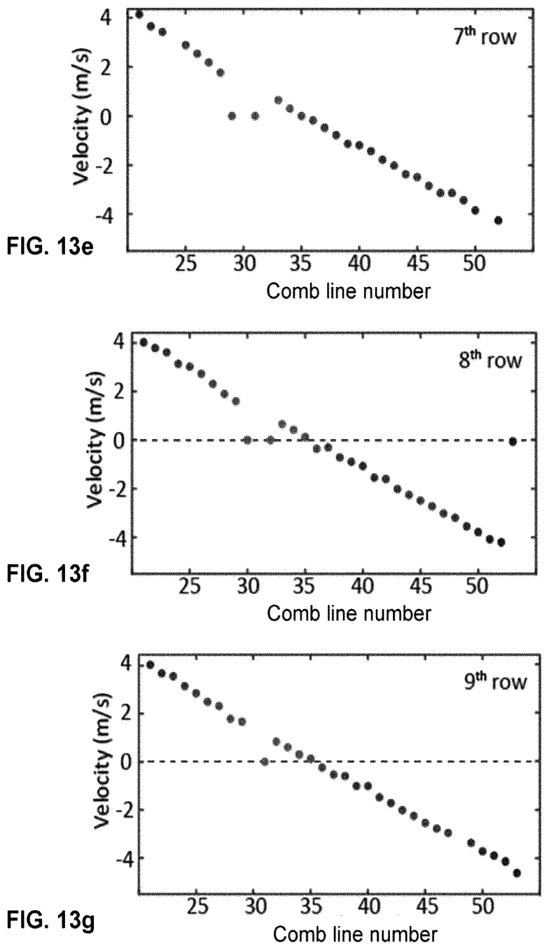

FIG. 13a schematically shows an excerpt of a measurement setup where the target 2 is a small aluminum flywheel that is covered with a lambertian reflector and which has a radius of 2 cm. A motor rotation frequency of 41 Hz was chosen. FIG. 13b depicts a zoom into FIG. 13a showing how the multiple signal frequencies fₛ (corresponding to comb lines of the signal radiation S generated in a signal microresonator 100 operated in the modulation-instability regime) are each hitting the target at a different point in space, thus also sampling different velocities. FIG. 13c shows a measured point cloud of the flywheel representing distance values, while FIG. 13d shows a measured point cloud of the flywheel representing velocity values. FIGS. 13e-g show horizontal velocity profiles of the 7th, 8th and 9th row, respectively, wherein the rows 7^{th}, 8^{th} and 9^{th} row are also marked in the point cloud shown in FIG. 13d. The velocity resolution depends on the measurement time and equates the Fourier transform limited linewidth, which results in 16 cm/s velocity resolution for a 10 μs measurement time per pixel. The comb lines located directly adjacent to the pump light frequency may lead to false detection due to an excess of ASE noise in the local-oscillation radiation. Small variations of the velocity are attributed to mechanical vibrations during the line-by-line measurement.

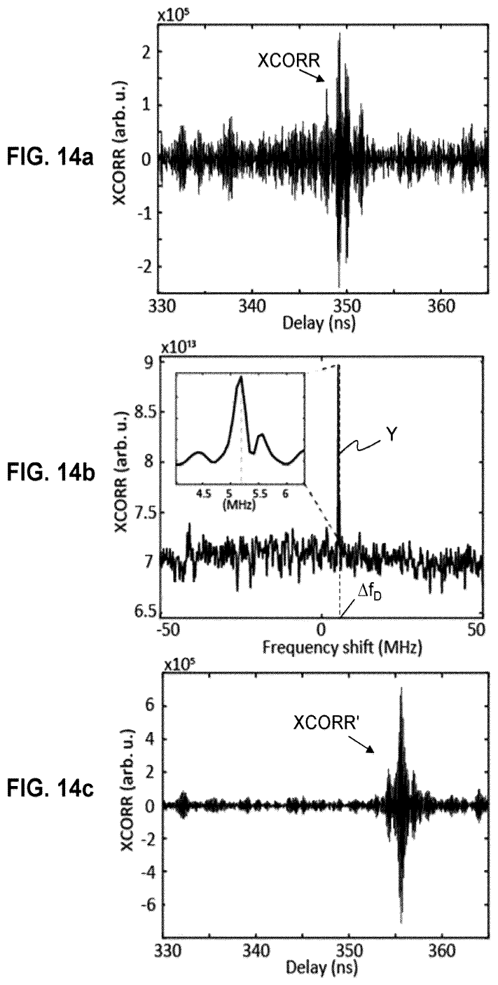

A procedure to obtain the distance and velocity values is illustrated in FIGS. 14a-c. FIG. 14a shows a direct cross-correlation time signal XCORR of the target current signal and the reference current signal to illustrate the issue of cross-correlation degradation in presence of a Doppler-frequency shift Δf_{D}. However, this issue can be easily solved via Doppler correction. The Doppler-frequency shift Δf_{D} is determined by Fourier-transforming the target signal I_{T} to obtain a target spectrum, by Fourier-transforming the reference signal I_{R} to obtain a reference spectrum and by subsequently cross-correlating the target spectrum and the reference spectrum to obtain a cross-correlation spectrum Y. In FIG. 14b, such a cross-correlation spectrum Y is shown, which exhibits a peak at ˜5.2 MHz corresponding to a Doppler-frequency shift Δf_{D} of a signal frequency fₛ that was used to detect a pixel moving at ˜4 m/s towards the target radiation beam. The inset in FIG. 14b corresponds to the zoom with a Fourier-transform limited resolution of 100 KHz. The target signal I_{T} is then downshifted by the Doppler-frequency shift Δf_{D} and cross-correlated again with the reference signal I_{R}, resulting in a corrected cross-correlation time signal XCORR′ shown in FIG. 14c. As can be seen, the signal-to-noise ratio (SNR) is substantially improved in FIG. 14c compared to FIG. 14a.

LIST OF REFERENCE SIGNS

| | |
|---|---|
| 1 | optical signal source |
| 2 | target |
| 3 | target photoreceiver module |
| 4 | reference photoreceiver module |
| 5, 5′ | continuous-wave laser |
| 6 | signal splitter |
| 7 | target demulitplexing unit |
| 8 | reference demultiplexing unit |
| 9 | local-oscillator demultiplexing unit |
| 10 | optical local-oscillator source |
| 12 | frequency shifter |
| 311 | first target balanced photodetector |
| 312 | second target balanced photodetector |
| 32 | target combination device |
| 411 | first reference balanced photodetector 411 |
| 412 | second reference balanced photodetector |
| 42 | reference combination device |
| 50 | evaluation arrangement |
| 51, 51′ | single-frequency laser module |
| 60 | optical pump amplifier |
| 61 | pump splitter |
| 70 | optical signal radiation amplifier |
| 70' | optical local-oscillator radiation amplifier |
| 80 | dispersive element |
| 90, 90′ | laser oscillator |
| 91 | modulator |
| 81 | collimator element |
| 82 | fiber optic circulator |
| 83 | optical target amplifier |
| 100 | signal microresonator |
| 101 | signal coupling waveguide |
| 110 | local-oscillator microresonator |
| 111 | the local-oscillator coupling waveguide |
| 200 | chip-scale signal platform |
| 210 | chip-scale local-oscillator platform |
| 1000 | detection arrangement |
| S | signal radiation |
| LO | local-oscillator radiation |
| T | target radiation part |
| R | reference radiation part |
| TR | reflected portion of the target radiation part |
| fₛ | signal frequency |
| f_{LO} | local-oscillator frequency |
| Δfₛ | spacing |
| Δf_{LO} | spacing |
| τ_{d} | time delay |
| d | distance |
| Δf_{G} | global frequency shift |
| Δf_{D} | Doppler-frequency shift |
| C_{T} | target channel |
| C_{R} | reference channel |
| C_{LO} | local-oscillator channel |
| C_{LO1} | first local-oscillator sub-channel |
| C_{LO2} | second local-oscillator sub-channel |
| P | channel pair |
| I_{T} | target signal |
| I_{R} | reference signal |
| TM | tuning means |
| IN1 | first input |
| IN2 | second input |
| IN11, IN21 | first branch |
| IN12, IN22 | second branch |
| PS | phase shifter |
| BS1 | first 50:50-beam-combiner/beam splitter |
| BS2 | second 50:50-beam combiner/beam splitter |
| O11, O12, | outputs |
| O21, O22 | |
| XCORR | cross-correlation time signal |
| XCORR_{d} | cross-correlation distance signal |
| XCORR′ | corrected cross-correlation time signal |
| Y | cross-correlation spectrum |
| ΔAM_{S} | amplitude modulation/noise bandwidth |
| ΔPMₛ | phase modulation/noise bandwidth |
| ΔFMₛ | frequency modulation/noise bandwidth |

1. A method for light detection and ranging, the method comprising:
generating signal radiation at multiple signal frequencies with an optical signal source, wherein the signal radiation exhibits random signal modulations;
splitting the signal radiation into a target radiation part and a reference radiation part;
directing the target radiation part towards a target;
detecting a target signal, wherein the target signal is associated with a reflected portion of the target radiation part being reflected from the target;
detecting a reference signal, wherein the reference signal is associated with the reference radiation part, and
deriving at least one ranging information parameter from the target signal and the reference signal.

2. The method according to claim 1, wherein the random signal modulations are at least one of random amplitude modulations or random phase modulations.

3. The method according to claim 1, wherein at least one of:
the signal radiation exhibits the random signal modulations at each of the multiple signal frequencies, or
wherein the signal frequencies are at least one of: discrete and spaced by an essentially constant signal frequency spacing.

4. The method according to claim 1, wherein deriving the at least one ranging information parameter comprises:
cross-correlating the target signal and the reference signal to obtain a cross-correlation time signal, and
inferring the at least one ranging information parameter from the cross-correlation time signal.

5. The method of claim 1, wherein the method further comprises:
Fourier-transforming the target signal to obtain a target spectrum;
Fourier-transforming the reference signal to obtain a reference spectrum;
cross-correlating the target spectrum and the reference spectrum to obtain a cross-correlation spectrum;
extracting a Doppler-frequency shift from the cross-correlation spectrum;
calculating a frequency-shifted target signal based on said Doppler-frequency shift;
cross-correlating the frequency-shifted target signal with the reference signal to obtain a corrected cross-correlation time signal, and
extracting a ranging information parameter associated with the target from the corrected cross-correlation time signal.

6. The method according to claim 1, wherein the optical signal source comprises a signal microresonator pumpable by a continuous-wave laser, and
wherein generating the signal radiation exhibiting the random signal modulations comprises operating the signal microresonator in a modulation-instability regime.

7. The method according to claim 1, wherein the optical signal source comprises a laser oscillator configured to emit a frequency comb and a modulator, and
wherein generating the signal radiation exhibiting the random signal modulations comprises:
running the laser oscillator such that it emits the frequency comb, and
randomly modulating said frequency comb using the modulator such that the frequency comb exhibits random modulations.

8. The method according to claim 1, wherein the optical signal source comprises a continuous-wave laser and a modulator, and
wherein generating the signal radiation exhibiting the random signal modulations comprises:
generating continuous-wave radiation using the continuous laser, and
generating a randomly modulated frequency comb from said continuous-wave radiation using the modulator.

9. The method according to claim 1, wherein the optical signal source comprises multiple single-frequency laser modules, wherein each single-frequency laser module is configured to emit randomly modulated radiation at one of the multiple signal frequencies, and
wherein generating the signal radiation exhibiting the random signal modulations comprises:
generating randomly modulated radiation with each single-frequency laser module at one of the multiple signal frequencies, and
combining the randomly modulated radiation of each single-frequency laser module to create the signal radiation.

10. The method according to claim 1, further comprising:
generating local-oscillator radiation with an optical local-oscillator source,
splitting the local-oscillator radiation into a first local-oscillator radiation part and a second local-oscillator radiation part,
combining the first local-oscillator radiation part with the reference radiation part and combining the second local-oscillator radiation part with the reflected portion of the target radiation part, and
detecting the reference signal and the target signal via coherent detection.

11. The method according to claim 10, wherein the local-oscillator radiation is generated at multiple local-oscillator frequencies,
wherein the local-oscillator frequencies are at least one of discrete and spaced by an essentially constant local-oscillator frequency spacing.

12. The method according to claim 10, wherein at least one of:
the signal radiation exhibits random signal phase modulations having a signal phase modulation bandwidth and the local-oscillator radiation exhibits random local-oscillator phase modulations having a local-oscillator phase modulation bandwidth being smaller than the signal phase modulation bandwidth or
the signal radiation exhibits random signal amplitude modulations having a signal amplitude modulation bandwidth and the local-oscillator radiation exhibits random local-oscillator amplitude modulations having a local-oscillator amplitude modulation bandwidth being smaller than the signal amplitude modulation bandwidth.

13. The method according to claim 10,
wherein the optical local-oscillator source comprises a local-oscillator microresonator pumpable by a continuous-wave laser, and
wherein generating the local-oscillator radiation comprises operating the local-oscillator microresonator in a soliton regime.

14. The method according to claim 10, wherein the optical local-oscillator source comprises a laser oscillator configured to emit a frequency comb, and
wherein generating the local-oscillator radiation comprises running the laser oscillator such that it emits the frequency comb.

15. The method according to claim 10, wherein the optical local-oscillator source comprises a continuous-wave laser and a modulator, and
wherein generating the local-oscillator radiation comprises:
generating continuous-wave radiation using the continuous-wave laser, and
generating a frequency comb from said continuous-wave radiation using the modulator.

16. The method according to claim 10, wherein the optical local-oscillator source comprises multiple single-frequency laser modules, wherein each single-frequency laser module is configured to emit radiation at one of the multiple local-oscillator frequencies, and
wherein generating the local-oscillator radiation comprises:
generating radiation with each single-frequency laser module at one of the multiple signal frequencies, and
combining the radiation of each single-frequency laser module to create the local-oscillator radiation.

17. The method according to claim 10, further comprising shifting the multiple signal frequencies by a global frequency shift with respect to the multiple local-oscillator frequencies of the local-oscillator radiation to enable a non-zero radio beat signal frequency between the multiple signal frequencies and the multiple local-oscillator frequencies.

18. A setup for light detection and ranging comprising:
at least one optical signal source being configured to generate signal radiation at multiple signal frequencies, wherein the signal radiation exhibits random signal modulations;
at least one signal splitter being configured to split the signal radiation into a target radiation part and a reference radiation part;
at least one detection arrangement being configured to detect a target signal and a reference signal, wherein the target signal is associated with a reflected portion of the target radiation part being reflected from a target—and the reference signal is associated with the reference radiation part, and
at least one evaluation arrangement being configured to derive at least one ranging information parameter from the target signal and the reference signal.

19. The setup according to claim 18, wherein the optical signal source comprises a signal microresonator pumpable by a continuous-wave laser such that the signal microresonator is operated in a modulation-instability regime.

20. The setup according to claim 18, wherein the optical signal source comprises a laser oscillator configured to emit a frequency comb and a modulator configured to randomly modulate said frequency comb.

21. The setup according to claim 18, wherein the optical signal source comprises a continuous-wave laser configured to emit continuous-wave radiation and a modulator configured to generate a randomly modulated frequency comb from said continuous-wave radiation.

22. The setup according to claim 18, wherein the optical signal source comprises multiple single-frequency laser modules, wherein each single-frequency laser module is configured to emit randomly modulated radiation at one of the multiple signal frequencies.

23. The setup according to claim 18, further comprising:
at least one optical local-oscillator source being configured to emit local-oscillator radiation;
at least one local-oscillator splitter being configured to split the local-oscillator radiation into a first local-oscillator radiation part and a second local-oscillator radiation part, and
wherein the detection arrangement is further configured to detect the reference signal and the target signal via coherent detection by combining the first local-oscillator radiation part with the reference radiation part and combining the second local-oscillator radiation part with the reflected portion of the target radiation part.

24. The setup according to claim 23, wherein the optical local-oscillator source comprises a local-oscillator microresonator pumpable by a continuous-wave laser such that the local-oscillator microresonator is operated in a soliton-regime.

25. The setup according to 23, wherein the optical local-oscillator source comprises a laser oscillator configured to emit a frequency comb.

26. The setup according to claim 23, wherein the optical local-oscillator source comprises a continuous-wave laser configured to emit continuous-wave radiation and a modulator configured to generate a frequency comb from said continuous-wave radiation.

27. The setup according to claim 23, wherein the optical local-oscillator source comprises multiple single-frequency laser modules, wherein each single-frequency laser module is configured to emit radiation at one of the multiple local-oscillator frequencies.

28. The setup according to claim 18, wherein the detection arrangement comprises:
a target demultiplexing unit comprising multiple target channels, wherein each target channel is configured to comprise one of the multiple signal frequencies;
a reference demultiplexing unit comprising multiple reference channels, wherein each reference channel is configured to comprise one of the multiple signal frequencies;
multiple target photoreceiver modules, wherein each target photoreceiver module is associated with one target channel;
multiple reference photoreceiver modules, wherein each reference photoreceiver module is associated with one reference channel,
wherein multiple channel pairs comprising each one target channel and one reference channel are formed, wherein for each channel pair the signal frequency comprised by the target channel and the signal frequency comprised by the reference channel are the same, and
wherein the detection arrangement is configured to detect the target signal for the target channel of each channel pair using the target photoreceiver module associated with said target channel and furthermore configured to detect the reference signal for the reference channel of each channel pair using the reference photoreceiver module associated with said reference channel.

29. The setup according to claim 28, wherein the detection arrangement further comprises:
a local-oscillator demultiplexing unit comprising multiple local-oscillator channels wherein each local-oscillator channel is configured to comprise one of the multiple local-oscillator frequencies;
multiple local-oscillator splitters configured to split the local-oscillator radiation of each local-oscillator channel into at least a first local-oscillator sub-channel and a second local-oscillator sub-channel;
wherein each reference photoreceiver module comprises a reference combination device combining said first local-oscillator sub-channel with one of the reference channels, and
wherein each target photoreceiver module comprises a target combination device combining said second local-oscillator sub-channel with one of the target channels.

30. The setup according to claim 29, wherein at least one of:
the target combination devices are optical hybrids,
each target photoreceiver module comprises a first target balanced photodetector and a second target balanced photodetector,
the multiple reference combination devices are optical hybrids, or
each reference photoreceiver module comprises a first reference balanced photodetector and a second reference balanced photodetector.

31. The setup according to claim 28, wherein at least one of:
the setup further comprises a frequency shifter configured to shift the multiple signal frequencies by a global frequency shift with respect to the multiple local-oscillator frequencies or vice versa,
each target photoreceiver module comprises a target balanced photodetector, or
each reference photoreceiver module comprises a reference balanced photodetector.

32. The method according to claim 3, wherein the random signal modulations have a modulation bandwidth being smaller than said frequency spacing.

33. The method according to claim 4, wherein the at least one ranging information parameter is at least one of a time delay or a distance.

34. The method according to claim 11, wherein the local-oscillator frequency spacing is essentially equal to a signal frequency spacing of the multiple signal frequencies.

35. The setup according to claim 23, wherein the optical local-oscillator source is configured to emit local-oscillator radiation at multiple local-oscillator frequencies.
